(19) United States
(12) Patent Application Publication
(10) Pub. No.: US 2024/0015732 A1
(43) Pub. Date: Jan. 11, 2024

(54) APERIODIC CSI OVER MULTI-TRP PUSCH

(71) Applicant: Telefonaktiebolaget LM Ericsson (publ), Stockholm (SE)

(72) Inventors: Siva Muruganathan, Stittsville (CA); Shiwei Gao, Nepean (CA); Yufei Blankenship, Kildeer, IL (US); Zhipeng Lin, Nanjing (CN)

(21) Appl. No.: 18/032,967

(22) PCT Filed: Oct. 25, 2021
(86) PCT No.: PCT/IB2021/059846

§ 371 Date: Apr. 20, 2023

Related U.S. Application Data
(60) Provisional application No. 63/105,045, filed on Oct. 23, 2020.

(30) Foreign Application Priority Data
Oct. 26, 2020 (WO) PCT/CN2020/123567

(51) Int. Cl. H04W 72/1268; H04W 16/28; H04L 5/00; H04W 72/232; H04B 7/06

(52) U.S. Cl. CPC H04W 72/1268; H04W 16/28; H04L 5/0051; H04W 72/232; H04B 7/0626

(57) ABSTRACT

Systems and methods for aperiodic Channel State Information (CSI) over multi-Transmission/Reception Point (TRP) Physical Uplink Shared Channel (PUSCH) are provided. In some embodiments, a method performed by a wireless device for providing feedback includes: repeating PUSCH over multiple M>1 PUSCH occasions with P spatial relations and/or Uplink Transmission Configuration Indicator (TCI) states; and multiplexing Aperiodic CSI (A-CSI) with PUSCH on N>=1 PUSCH transmission occasions wherein N includes at least one PUSCH transmission occasion associated with each of the P spatial relations or UL TCI states. This may enable improved A-CSI reliability in multi-TRP scenarios. By repeating A-CSI (multiplexed with PUSCH or not multiplexed with PUSCH) over multiple TRPs, the reliability of A-CSI can be improved since the A-CSI can be received by at least one TRP. This method is particularly beneficial in FR2 cases where the channel between a TRP and a UE can experience channel blocking.

### RELATED APPLICATIONS

This application claims the benefit of provisional patent application Ser. No. 63/105,045; filed Oct. 23, 2020, and PCT patent application serial number PCT/CN2020/123567, filed Oct. 26, 2020, the disclosures of which are hereby incorporated herein by reference in their entireties.

### TECHNICAL FIELD

The present disclosure relates generally to providing feedback.

### BACKGROUND

New Radio (NR) uses CP-OFDM (Cyclic Prefix Orthogonal Frequency Division Multiplexing) in both downlink (DL) (i.e., from a network node, gNB, or base station, to a user equipment or UE) and uplink (UL) (i.e., from UE to gNB). Discrete Fourier Transform spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel, either PDSCH(physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈{0, 1, 2, 3, 4}. Δf=15 kHz is the basic subcarrier spacing. The slot durations at different subcarrier spacings is given by 1/2^{μ} ms.

In the frequency domain, a system bandwidth is divided into resource blocks (RBs), each corresponds to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

In NR Rel-15, uplink data transmission can be dynamically scheduled using PDCCH. A UE first decodes uplink grants in PDCCH and then transmits data over PUSCH based the decoded control information in the uplink grant such as modulation order, coding rate, uplink resource allocation, etc.

In addition to dynamic scheduling, semi-persistent transmission of PUSCH using configured grants (CG) is also supported in NR. There are two types of CG based PUSCH defined in NR Rel-15. In CG type 1, a periodicity of PUSCH transmission as well as the time domain offset are configured by Radio Resource Control (RRC). In CG type 2, a periodicity of PUSCH transmission is configured by RRC and then the activation and release of such transmission is controlled by Downlink Control Information (DCI), i.e., with a PDCCH.

In NR, it is possible to schedule a PUSCH with time repetition, by the RRC parameter pusch-AggregationFactor (for dynamically scheduled PUSCH), and repK (for

PUSCH with configured grant). In this case, a PUSCH is repeated in multiple adjacent slots (if the slot is available for UL) up until the number of repetitions configured.

For a configured grant, the redundancy version (RV) sequence to be used is configured by the repK-RV field when repetitions are used. If repetitions are not used for PUSCH, the repK-RV field is absent.

In NR Release-15, there are two PUSCH mapping types supported, Type A and Type B. Type A is usually referred to as slot-based while Type B transmissions may be referred to as non-slot-based or mini-slot-based.

Mini-slot based PUSCH transmissions can be of any length for uplink and can start and end in any symbol within a slot. Note that mini-slot transmissions in NR Rel-15 may not cross the slot-border.

### Channel State Information (CSI) and CSI Feedback

A core component in LTE and NR is the support of MIMO antenna deployments and Multiple Input Multiple Output (MIMO) related techniques. Spatial multiplexing is one of the MIMO techniques used to achieve high data rates in favorable channel conditions.

For an antenna array with Ni antenna ports at the gNB for transmitting rDL symbols s=[s₁,s₂, . . . ,sᵣ]^{T}, the received signal at a UE with N_{R} receive antennas at a certain RE n can be expressed as:

yₙ=HₙWₛ+eₙ

where yₙ is a N_{R}×1 received signal vector; Hₙ a N_{R}×N_{T} channel matrix at the RE between the gNB and the UE; W is an Nᵣ×r precoder matrix; eₙ is a N_{R}×1 noise plus interference vector received at the RE by the UE. The precoder W can be a wideband precoder, i.e., constant over a whole bandwidth part (BWP), or a subband precoder, i.e., constant over each subband.

The precoder matrix is typically selected from a codebook of possible precoder matrices, and typically indicated by means of a precoder matrix indicator (PMI), which specifies a unique precoder matrix in the codebook for a given number of symbol streams. The r symbols in s each corresponds to a spatial layer and r is referred to as the transmission rank.

The transmission rank is also dependent on the Signal to noise plus interference ratio (SINR) observed at the UE. Typically, a higher SINR is required for transmissions with higher ranks. For efficient performance, it is important that a transmission rank that matches the channel properties as well as the interference observed at a UE. For a given block error rate, the modulation level and coding scheme (MCS) is determined by the SINR, or channel quality. The precoding matrix, the transmission rank, and the channel quality are part of channel state information (CSI), which is typically measured by a UE and fed back to a network node or gNB.

Like in LTE, NR has adopted an implicit CSI mechanism where a UE feeds back the downlink CSI as one or more of a transmission rank indicator (RI), a precoder matrix indicator (PMI), and one or two channel quality indicator(s) (CQI). NR supports transmission of either one or two transport blocks (TBs) to a UE in a slot, depending on the rank. One TB is used for ranks 1 to 4, and two TBs are used for ranks 5 to 8. A CQI is associated to each TB. The CQI/RI/PMI report can be either wideband or subband based on configuration.

### Channel State Information Reference Signal (CSI-RS) and CSI-IM

Similar to LTE, CSI-RS was introduced in NR for channel estimations in the downlink. A CSI-RS is transmitted on each transmit antenna port and is used by a UE to measure downlink channel associated with each of antenna ports. Up to 32 CSI reference signals are defined. The antenna ports are also referred to as CSI-RS ports. The supported number of antenna ports in NR are {1,2,4,8,12,16,24,32}. By measuring the received CSI-RS, a UE can estimate the channel the CSI-RS is traversing, including the radio propagation channel and antenna gains. CSI-RS for this purpose is also referred to as Non-Zero Power (NZP) CSI-RS.

NZP CSI-RS can be configured to be transmitted in certain REs per PRB. FIG. 3 shows an example of a NZP CSI-RS resource configuration with 4 CSI-RS ports in a PRB in one slot.

In addition to NZP CSI-RS, Zero Power (ZP) CSI-RS was introduced in NR. The purpose is to indicate to a UE that the associated REs are muted at the gNB. If the ZP CSI-RS is allocated to be fully overlapping with NZP CSI-RS in an adjacent cell, it can be used to improve channel estimation by UEs in the adjacent cell since there is no interference created by this cell.

CSI resource for interference measurement, CSI-IM, is used in NR for a UE to measure noise and interference, typically from other cells. CSI-IM comprises of 4 REs in a slot. In NR, two different CSI-IM patterns are possible: The CSI-IM pattern can be either 4 consecutive REs in one OFDM symbol or two consecutive REs in both frequency and time domains. An example is shown in FIG. 3. Typically, gNB does not transmit any signal in the CSI-IM resource so that what observed in the resource is noise and interference from other cells.

By measuring both the channel based on a NZP CSI-RS resource and interference based on a CSI-IM resource, a UE can estimate the CSI, i.e. RI, PMI, and CQI(s).

### CSI Framework in NR

In NR, a UE can be configured with one or multiple CSI report configurations. Each CSI report configuration is associated with a BWP and contains all the necessary information required for a CSI report, including:
a CSI resource configuration for channel measurement
a CSI-IM resource configuration for interference measurement
reporting type, i.e., aperiodic CSI (on PUSCH), periodic CSI (on PUCCH) or semi-persistent CSI (on PUCCH, and DCI activated on PUSCH).
report quantity specifying what to be reported, such as RI, PMI, CQI
codebook configuration such as type I or type II CSI
frequency domain configuration, i.e., subband vs. wideband CQI or PMI, and subband size
CQI table to be used

A UE can be configured with one or multiple CSI resource configurations for channel measurement and one or more CSI-IM resources for interference measurement. Each CSI resource configuration for channel measurement can contain one or more NZP CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

Periodic CSI starts after it has been configured by RRC and is reported on PUCCH, the associated NZP CSI-RS resource(s) and CSI-IM resource(s) are also periodic.

For semi-persistent CSI, it can be either on PUCCH or PUSCH. Semi-persistent CSI on PUCCH is activated or deactivated by a MAC CE command. Semi-persistent CSI on PUSCH is activated or deactivated by DCI. The associated NZP CSI-RS resource(s) and CSI-IM resource(s) can be either periodic or semi-persistent.

For aperiodic CSI, it is reported on PUSCH and is activated by a CSI request bit field in DCI. The associated NZP CSI-RS resource(s) and CSI-IM resource(s) can be either periodic, semi-persistent, or aperiodic. The linkage between a code point of the CSI request field and a CSI report configuration is via an aperiodic CSI trigger state. A UE is configured by higher layer a list of aperiodic CSI trigger states, where each of the trigger states contains an associated CSI report configuration. The CSI request field is used to indicate one of the aperiodic CSI trigger states and thus, one CSI report configuration.

If there are more than one NZP CSI-RS resource set and/or more than one CSI-IM resource set are associated with a CSI report configuration, only one NZP CSI-RS resource set and one CSI-IM resource set are selected in the aperiodic CSI trigger state. Thus, each aperiodic CSI report is based on a single NZP CSI-RS resource set and a single CSI-IM resource set.

In most of the scenarios, a NZP CSI-RS resource set contains only one NZP CSI-RS resource and a CSI-IM resource set contains a single CSI-IM resource. In some multi-beam scenarios where gNB has multiple DL beams and wants to know the best beam plus the associated CSI for a UE, multiple NZP CSI-RS resources, each associated with a beam, may be configured in a NZP CSI-RS resource set. The UE would select one NZP CSI-RS resource associated with the best beam and report a CSI associated with NZP CSI-RS resource. A CRI (CSI-RS resource indicator) would be reported as part of the CSI. In this case, the same number of CSI-IM resources, each paired with a NZP CSI-RS resource need to be configured in the associated CSI-IM resource set. That is, when a UE reports a CRI value k, this corresponds to the (k+1)^{th} entry of the NZP CSI-RS resource set for channel measurement, and, if configured, the (k+1)^{th} entry of the CSI-IM resource set for interference measurement (clause 5.2.1.4.2 of 3GPP TS 38.214).

FIG. 4 shows an example of aperiodic CSI reporting based on an aperiodic NZP CSI-RS resource for channel measurement and a CSI-IM resource for interference measurement. The CSI is computed based on the aperiodic NZP-CSI-RS and CSI-IM triggered after the DCI. FIG. 5 is an example of aperiodic CSI reporting based on a periodic or semi-persistent NZP CSI-RS resource and a periodic or semi-persistent CSI-IM resource. In this case, the CSI is computed based on the channel and interference measurements done before the DCI triggering the CSI request.

### NR Release 16 PUSCH Enhancements

In NR Release 16, PUSCH repetition enhancements were made for both PUSCH type A and type B for the purposes of further latency reduction (i.e., for Rel-16 URLLC).

### PUSCH Repetition Type A (Slot Based) Enhancements

In NR Rel-15, the number of aggregated slots for both dynamic grant and configured grant Type 2 are RRC configured. In NR Rel-16, this was enhanced so that the number of repetitions can be dynamically indicated, i.e. change from one PUSCH scheduling occasion to the next. That is, in addition to the starting symbol S, and the length of the PUSCH L, a number of nominal repetitions K is signaled as part of time-domain resource allocation (TDRA). Furthermore, the maximum number of aggregated slots was increased to K=16 to account for DL heavy TDD patterns.

For both Type 1 and Type 2 PUSCH transmissions with a configured grant, when K>1, the UE shall repeat the TB across the K consecutive slots applying the same symbol allocation in each slot.

A Type 1 or Type 2 PUSCH transmission with a configured grant in a slot is omitted according to the conditions in Clause 9, Clause 11.1 and Clause 11.2A of 3GPP TS38.213. Thus, the number of repetitions K is nominal since some slots may be DL slots and are then skipped for PUSCH transmissions.

Inter-slot and intra-slot hopping can be applied for Type A repetition.

### PUSCH Repetition Type B (Mini-Slot Based) Enhancements

PUSCH repetition Type B applies both to dynamic and configured grants. Type B PUSCH repetition can cross the slot boundary in Rel-16. When scheduling a transmission with PUSCH repetition Type B, in addition to the starting symbol S, and the length of the PUSCH L, a number of nominal repetitions K is signaled as part of time-domain resource allocation (TDRA) in NR Rel-16. To determine the actual time domain allocation of Type B PUSCH repetitions, a two-step process is used:
1. Allocate K nominal repetitions of length L back-to-back (adjacent in time), ignoring slot boundaries and TDD pattern.
2. If a nominal repetition crosses a slot boundary or occupies symbols not usable for UL transmission (e.g. UL/DL switching points due to TDD pattern), the offending nominal repetition may be split into two or more shorter actual repetitions. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot.

An example in which a nominal repetition crosses a slot boundary is shown in FIG. 6. Four nominal repetitions are allocated back-to-back, starting in slot 1 and continuing in slot 2. The second nominal repetition crosses the slot border and is split into two actual repetitions.

Each repetition contains DMRS, with the position of the DMRS in each repetition following Rel-15 rules.

Inter-slot frequency hopping and inter-repetition frequency hopping can be configured for Type B repetition.

### Spatial Relation Definition

Spatial relation is used in NR to refer to a relationship between an UL reference signal (RS) to be transmitted such as PUCCH/PUSCH DMRS (demodulation reference signal) and another previously transmitted or received RS, which can be either a DL RS (CSI-RS (channel state information RS) or SSB (synchronization signal block)) or an UL RS (SRS (sounding reference signal)). This is also defined from a UE perspective.

If an UL transmitted RS is spatially related to a DL RS, it means that the UE should transmit the UL RS in the opposite (reciprocal) direction from which it received the DL RS previously. More precisely, the UE should apply the “same” Transmit (Tx) spatial filtering configuration for the transmission of the UL RS as the Rx spatial filtering configuration it used to receive the spatially related DL RS previously. Here, the terminology ‘spatial filtering configuration’ may refer to the antenna weights that are applied at either the transmitter or the receiver for data/control transmission/reception. Another way to describe this is that the same “beam” should be used to transmit the signal from the UE as was used to receive the previous DL RS signal. The DL RS is also referred as the spatial filter reference signal.

On the other hand, if a first UL RS is spatially related to a second UL RS, then the UE should apply the same Tx spatial filtering configuration for the transmission for the first UL RS as the Tx spatial filtering configuration it used to transmit the second UL RS previously. In other words, same beam is used to transmit the first and second UL RS respectively.

Since the UL RS is associated with a layer of PUSCH or PUCCH transmission, it is understood that the PUSCH/PUCCH is also transmitted with the same TX spatial filter as the associated UL RS.

### TCI States for Uplink

In NR Rel-15, the handling of spatial transmission properties is different for PUSCH, PUCCH, and SRS. For PUCCH, the spatial relation information is defined in information element PUCCH-SpatialRelationInfo, and the spatial relation information for SRS is configured as part of SRS resource configuration. The spatial transmission properties for PUSCH are given by the spatial transmission properties associated with the SRS(s) configured in SRS resource set with usage of ‘Codebook’ or ‘non-Codebook’. In [1], it is argued that the Rel-15 way of handling the spatial transmission properties is cumbersome and inflexible when it comes to uplink multi-panel transmission in NR. Hence, in [1], TCI states for uplink are proposed that can be used to control the spatial properties of all the UL transmissions (i.e., PUSCH, PUCCH, and SRS). The focus in [1] is to be able to use uplink TCI state indication to select one of the uplink panels and the corresponding transmission beam (i.e., transmission properties) at the UE to transmit UL PUSCH/PUCCH/SRS when the UE is equipped with multiple panels.

In general, TCI states for uplink are configured by higher layers (i.e., RRC) for a UE. There are multiple ways of configuring uplink TCI state.
In one case, the UL TCI states are dedicated to only uplink and are configured separately from the TCI states corresponding to downlink. For example, the UL TCI states can be configured as part of the PUSCH-Config information element. Each uplink TCI state may indicate a transmission configuration which contains a DL RS (e.g., NZP CSI-RS or SSB) or an UL RS (e.g., SRS) with the purpose of indicating a spatial relation for PUSCH DMRS. Alternatively, the UL TCI states may be configured as part of BWP-UplinkDedicated information element such that the same UL TCI state can be used to indicate a DL RS or UL RS which provides the spatial relation for more than one of PUSCH DMRS, PUCCH DMRS, and SRS.
In another case, the same list of TCI states is used for DL and UL, hence the UE is configured with a single list of TCI states which can be used for both UL and DL scheduling. The single list of TCI states in this case are configured as part of for example the PDSCH-Config or the BWP-UplinkDedicated information elements.

### PUSCH Transmission Schemes

In NR, there are two transmission schemes specified for PUSCH.

### Codebook Based PUSCH

The Codebook based UL transmission is used on both NR and LTE and was motivated to be used for non-calibrated UEs and/or FDD. Codebook based PUSCH in NR is enabled if higher layer parameter txConfig=codebook. For dynamically scheduled PUSCH and configured grant PUSCH type 2, the Codebook based PUSCH transmission scheme can be summarized as follows:
the UE transmits one or two SRS resources (i.e., one or two SRS resources configured in the SRS resource set associated with the higher layer parameter usage of value rodeBook)
the gNB determines a preferred MIMO transmit precoder for PUSCH (i.e., transmit precoding matrix indicator or TPMI) from a codebook and the associated number of layers corresponding to the one or two SRS resources.
the gNB indicates a selected SRS resource via a 1-bit ‘SRS resource indicator’ field if two SRS resources are configured in the SRS resource set. The ‘SRS resource indicator’ field is not indicated in DCI if only one SRS resource is configured in the SRS resource set.
The gNB indicates a TPMI and the associated number of layers corresponding to the indicated SRS resource (in case 2 SRS resources are used) or the configured SRS resource (in case of 1 SRS resource is used). TPMI and the number of PUSCH layers is indicated by the ‘Precoding information and number of layers’ field in DCI formats 0_1 and 0_2. the UE performs PUSCH transmission using the TPMI and number of layers indicated.

For configured grant PUSCH type 1, SRI and TPMI are configured in configuredGrantConfig.

### Non-Codebook Based PUSCH

Non-Codebook based UL transmission is available in NR, enabling reciprocity-based UL transmission. By assigning a DL CSI-RS to the UE, it can measure and deduce suitable precoder weights for PUSCH transmission of up to four spatial layers. The candidate precoder weights are transmitted using up to four single-port SRS resources corresponding to the spatial layers. Subsequently, the gNB indicates the transmission rank and multiple SRS resource indicators (SRIs), jointly encoded using

$$\\ ⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits ,$$

where N_{SRS} indicates the number of configured SRS resources, and Lₘₐₓ is the maximum number of supported layers for PUSCH. For dynamically scheduled PUSCH, SRI(s) are indicated in the corresponding DCI. For configured grant PUSCH type 2, SRI(s) are indicated in the corresponding DCI activating the CG.

For configured grant PUSCH type 1, SRI(s) are configured in configuredGrantConfig.

### A-CSI Reporting in NR R15 and R16

In NR, the following types of CSI reporting are supported:
Periodic CSI Reporting: CSI is reported periodically by the UE. Parameters such as periodicity and slot offset are configured semi-statically, by higher layer signaling from the gNB to the UE.
Aperiodic CSI (A-CSI) Reporting: This type of CSI reporting involves a single-shot (i.e., one time) CSI report by the UE, which is dynamically triggered by the gNB, e.g. by the DCI in PDCCH. Some of the parameters related to the configuration of the aperiodic CSI report is semi-statically configured from the gNB to the UE but the triggering is dynamic.
Semi-Persistent CSI Reporting: similar to periodic CSI reporting, semi-persistent CSI reporting has a periodicity and slot offset which may be semi-statically configured by the gNB to the UE. However, a dynamic trigger from gNB to UE may be needed to allow the UE to begin semi-persistent CSI reporting. In some cases, a dynamic trigger from gNB to UE may be needed to command the UE to stop the semi-persistent transmission of CSI reports.

### 3GPP R15 Discussion on A-CSI on PUSCH With Slot Aggregation

In 3GPP RANI., A-CSI multiplexing on PUSCH with slot aggregation was discussed, and the following conclusion was drawn:

Conclusion
Conclusion in RAN1#96 with respect to A-CSI multiplexing in PUSCH
with slot aggregation is interpreted as the following:
When PUSCH slot aggregation is enabled, if A-CSI triggered by a DCI
that schedules a PUSCH in a slot, the A-CSI is multiplexed only in the
PUSCH in the first slot.
No changes to the specifications are needed.

Hence, based on the above conclusion, even though PUSCH may be repeated, A-CSI is not repeated and is only multiplexed onto the PUSCH in the first slot.

### 3GPP R16 Discussion on A-CSI/SP-CSI on PUSCH With Repetition Type B

During the discussion in NR Rel 16, some companies proposed that A-CSI without UL-SCH can be repeated over PUSCH repetition Type B where A-CSI is sent in
All actual repetitions, or
1st actual repetition of every nominal repetition

However, as shown in agreement, A-CSI repetition without UL-SCH was not agreed in R16.

For A-CSI transmission without UL-SCH if PUSCH repetition Type B is configured, companies who supported A-CSI report only on one repetition proposed transmitting the A-CSI in
1st actual repetition of all actual repetitions w.r.t nominal repetitions (agreed)
Last actual repetition
the longest actual repetition

In Rel-16, the following agreements were made:

Agreement
For CSI report(s) triggered by DCI on PUSCH repetition Type B without
UL-SCH,
CSI report(s) is carried on the first nominal repetition.
For A-CSI and the first PUSCH carrying SP-CSI after activation, the first
nominal repetition is expected to be the same as the first actual
repetition.
For PUSCH carrying SP-CSI other than the first one after activation,
If the first nominal repetition is not the same as the first actual
repetition, the first nominal repetition is not transmitted;
Otherwise, whether/how the first nominal repetition is dropped
follows Rel-15 behavior for PUSCH repetition Type A with SP-CSI
multiplexing.
All the other nominal repetitions are discarded, and these repetitions are
not considered (i.e., treated as non-existing) when determining UCI
multiplexing on PUSCH.
Agreement
For CSI report(s) triggered by DCI on PUSCH repetition Type B with
UL-SCH, CSI report(s) is transmitted on the first actual repetition.

According to the above agreement:
when A-CSI is transmitted on PUSCH with repetition Type B with UL-SCH, the A-CSI is transmitted on the first actual repetition.
when A-CSI is transmitted on PUSCH with repetition TypeB without UL-SCH, the A-CSI is carried on the first nonminal repetition. The first nombial repetition is expected to be the same as the first actual repetition.

Improved systems and methods for providing feedback are needed.

### SUMMARY

Systems and methods for aperiodic Channel State Information (CSI) over multi-Transmission/Reception Point (TRP) Physical Uplink Shared Channel (PUSCH) are provided. In some embodiments, a method performed by a wireless device for providing feedback includes: repeating PUSCH over multiple M>1 PUSCH occasions with P spatial relations and/or Uplink Transmission Configuration Indicator (TCI) states; and multiplexing Aperiodic CSI (A-CSI) with PUSCH on N′>=1 PUSCH transmission occasions wherein N′ includes at least one PUSCH transmission occasion associated with each of the P spatial relations or UL TCI states. This may enable improved A-CSI reliability in multi-TRP scenarios. By repeating A-CSI (multiplexed with PUSCH or not multiplexed with PUSCH) over multiple TRPs, the reliability of A-CSI can be improved since the A-CSI can be received by at least one TRP. This method is particularly beneficial in FR2 cases where the channel between a TRP and a UE can experience channel blocking.

Certain aspects of the present disclosure and their embodiments may provide solutions to the aforementioned or other challenges. Some embodiments of the current disclosure include repeating A-CSI over multiple PUSCH transmission occasions targeting different TRPs. The A-CSI may be repeated at least once towards each TRP.

Method for transmitting A-CSI on PUSCH, the method including one or more of:
repeating PUSCH over multiple M>1 PUSCH occasions with P spatial relations or UL TCI states, and
multiplexing A-CSI with PUSCH on N′>=1 PUSCH transmission occasions wherein N′ includes at least one PUSCH transmission occasion associated with each of the P spatial relations or UL TCI states.

There are, proposed herein, various embodiments which address one or more of the issues disclosed herein.

Certain embodiments may provide one or more of the following technical advantage(s). The proposed methods improve A-CSI reliability in multi-TRP scenarios. By repeating A-CSI (multiplexed with PUSCH or not multiplexed with PUSCH) over multiple TRPs, the reliability of A-CSI can be improved since the A-CSI can be received by at least one TRP. This method is particularly beneficial in FR2 cases where the channel between a TRP and a UE can experience channel blocking.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of data scheduling in New Radio (NR) which is typically in slot basis, as shown with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH);

FIG. 2 illustrates the basic NR physical time-frequency resource grid where only one Resource Block (RB) within a 14-symbol slot is shown;

FIG. 3 illustrates an example of a Non-Zero Power (NZP) CSI-RS resource configuration with four Channel State Information Reference Signal (CSI-RS) ports in a PRB in one slot;

FIG. 4 illustrates an example of aperiodic CSI reporting based on an aperiodic NZP CSI-RS resource for channel measurement and a CSI-IM resource for interference measurement;

FIG. 5 illustrates an example of aperiodic CSI reporting based on a periodic or semi-persistent NZP CSI-RS resource and a periodic or semi-persistent CSI-IM resource;

FIG. 6 illustrates an example in which a nominal repetition crosses a slot boundary;

FIG. 7 illustrates one example of a cellular communications system in which embodiments of the present disclosure may be implemented;

FIG. 8 illustrates an example where PUSCH is repeated across four slots (where each repetition is a transmission occasion of the PUSCH), according to some other embodiments of the present disclosure;

FIG. 9 illustrates an example when the SRI mapping over PUSCH transmission is configured to be sequential, the A-CSI is multiplexed with PUSCH in the first PUSCH occasion and the third PUSCH occasion, according to some other embodiments of the present disclosure;

FIG. 10 illustrates an example where PUSCH is repeated across eight slots and the UE uses beams 1 and 2 to respectively transmit to TRP1 and TRP2, according to some other embodiments of the present disclosure;

FIG. 11(a) illustrates the nominal repetitions are the same as actual repetitions and the CSI is transmitted to both TRP1 and TRP2; and FIG. 11(b) illustrates the 2^{nd} nominal repetition is not the same as the 2^{nd} actual repetition due to slot boundary crossing, in this case the CSI is only transmitted in the first repetition to TRP1, according to some other embodiments of the present disclosure;

FIG. 12 is a schematic block diagram of a radio access node according to some embodiments of the present disclosure;

FIG. 13 is a schematic block diagram that illustrates a virtualized embodiment of the radio access node according to some embodiments of the present disclosure;

FIG. 14 is a schematic block diagram of the radio access node according to some other embodiments of the present disclosure;

FIG. 15 is a schematic block diagram of a wireless communication device according to some embodiments of the present disclosure;

FIG. 16 is a schematic block diagram of the wireless communication device according to some other embodiments of the present disclosure;

FIG. 17 illustrates a communication system includes a telecommunication network, such as a Third Generation Partnership Project (3GPP)-type cellular network, which comprises an access network, such as a Radio Access Network (RAN), and a core network according to some other embodiments of the present disclosure;

FIG. 18 illustrates a communication system, a host computer comprises hardware including a communication interface configured to set up and maintain a wired or wireless connection with an interface of a different communication device of the communication system according to some other embodiments of the present disclosure; and

FIGS. 19 to 22 illustrate methods implemented in a communication system, according to some other embodiments of the present disclosure.

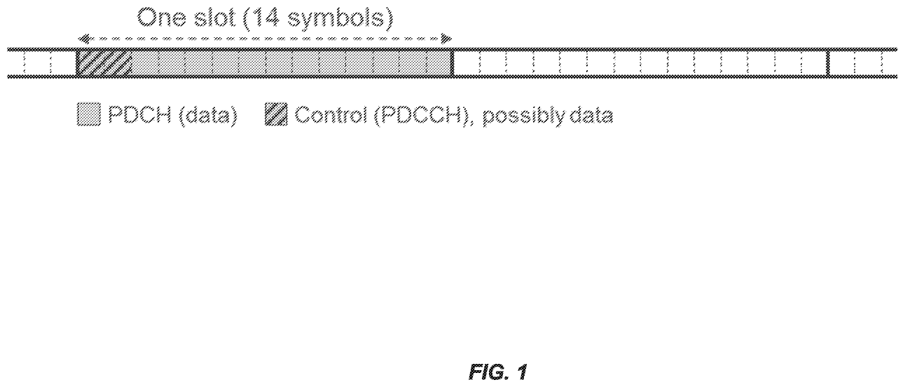

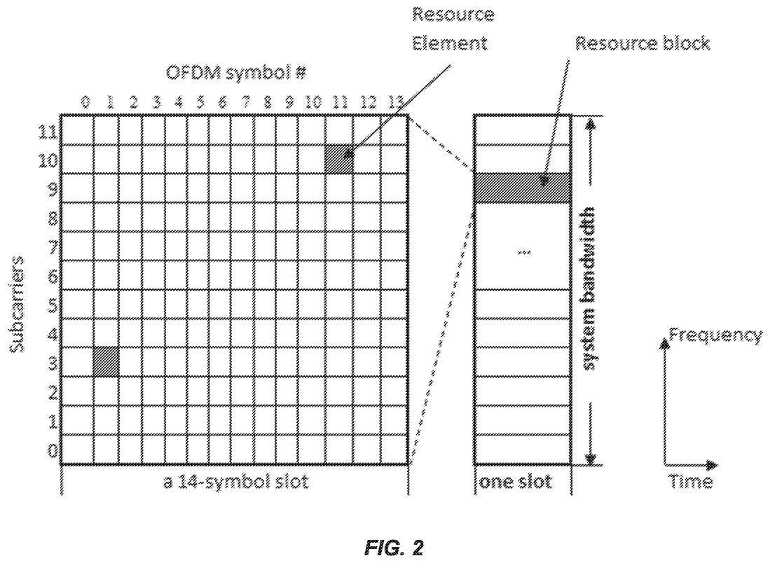

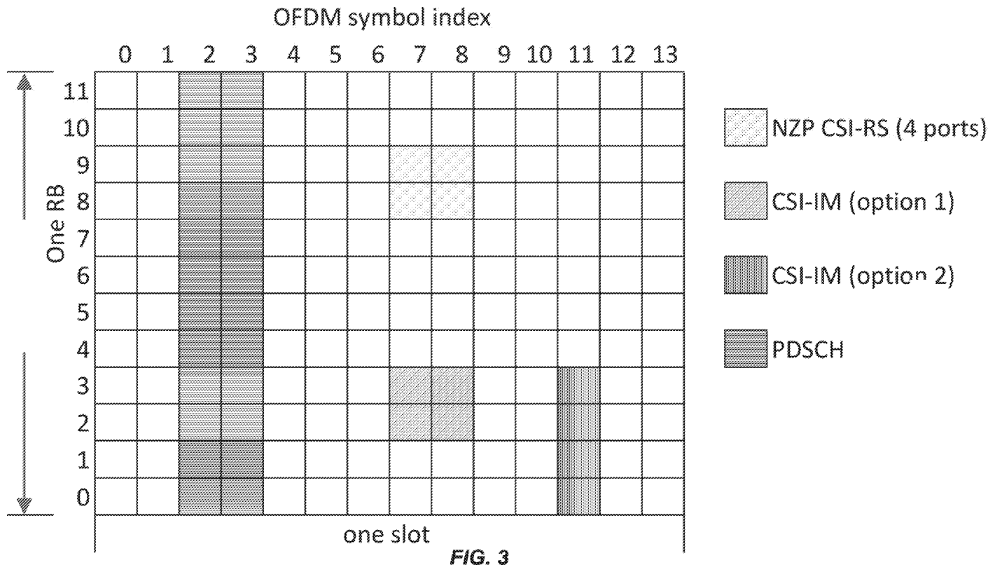

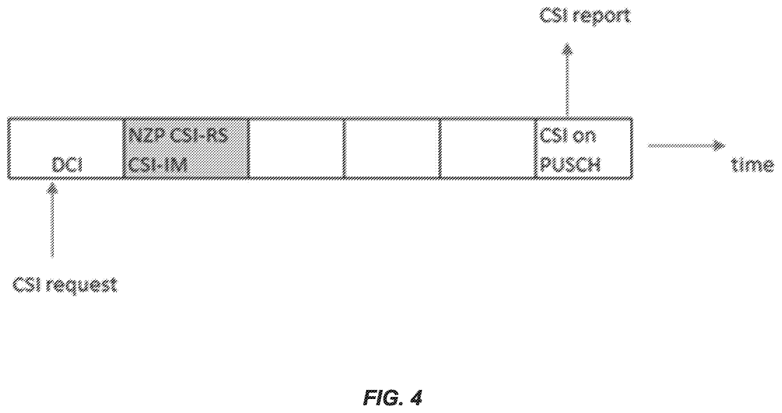

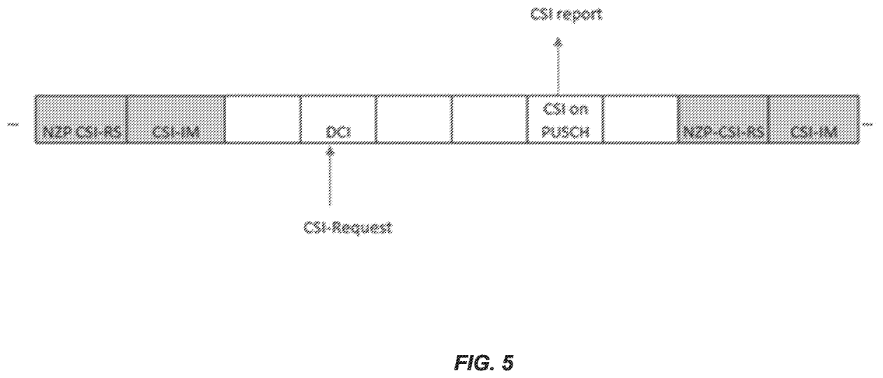

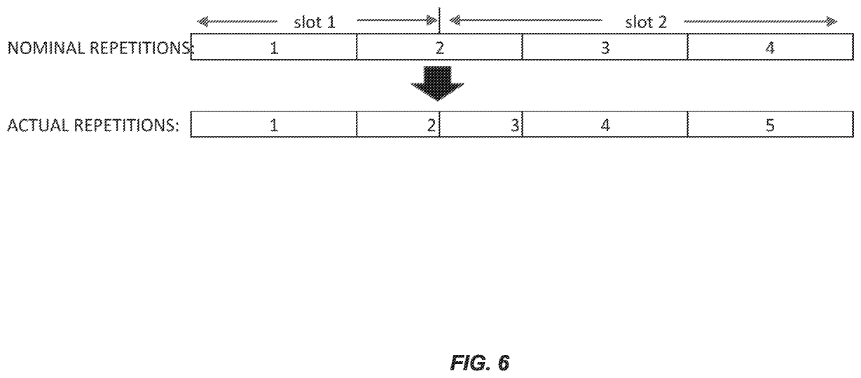

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC). In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

There currently exist certain challenges. In NR up to Release 16, aperiodic CSI report is sent once on PUSCH even when PUSCH is repeated (i.e., in the first repetition). If the CSI report is not correctly decoded by the gNB, the gNB discards the report and triggers UE for another A-CSI report. In frequency range 2 (FR2), channel blocking is a particular problem that needs to be overcome. If the A-CSI is transmitted by the UE in a slot when the channel between the UE and the TRP (transmission/reception point; note here that the TRP is within the gNB) is blocked, then the A-CSI cannot be received with sufficient quality and decoding of the A-CSI will fail at the gNB.

Deploying multiple TRPs (which are all part of a gNB) is one of the efficient ways to combat channel blocking in FR2. However, with current A-CSI reporting in NR, A-CSI is only sent once by the UE. Then, how to ensure reliability of A-CSI in an FR2 scenario with multi-TRP deployment is an open problem that needs to be solved.

Systems and methods for aperiodic Channel State Information (CSI) over multi-Transmission/Reception Point (TRP) Physical Uplink Shared Channel (PUSCH) are provided. In some embodiments, a method performed by a wireless device for providing feedback includes: repeating PUSCH over multiple M>1 PUSCH occasions with P spatial relations and/or Uplink Transmission Configuration Indicator (TCI) states; and multiplexing Aperiodic CSI (A-CSI) with PUSCH on N′>=1 PUSCH transmission occasions wherein N′ includes at least one PUSCH transmission occasion associated with each of the P spatial relations or UL TCI states. This may enable improved A-CSI reliability in multi-TRP scenarios. By repeating A-CSI (multiplexed with PUSCH or not multiplexed with PUSCH) over multiple TRPs, the reliability of A-CSI can be improved since the A-CSI can be received by at least one TRP. This method is particularly beneficial in FR2 cases where the channel between a TRP and a UE can experience channel blocking.

Deploying multiple TRPs (which are all part of a gNB) is one of the efficient ways to combat channel blocking in FR2. However, with current A-CSI reporting in NR, A-CSI is only sent once by the UE. Then, how to ensure reliability of A-CSI in an FR2 scenario with multi-TRP deployment is an open problem that needs to be solved.

Some embodiments of the current disclosure include repeating A-CSI over multiple PUSCH transmission occasions targeting different TRPs. The A-CSI may be repeated at least once towards each TRP.

Method for transmitting A-CSI on PUSCH, the method including one or more of:
repeating PUSCH over multiple M>1 PUSCH occasions with P spatial relations or UL TCI states, and
multiplexing A-CSI with PUSCH on N′>=1 PUSCH transmission occasions wherein N′ includes at least one PUSCH transmission occasion associated with each of the P spatial relations or UL TCI states.

In the following embodiments, the term TRP is used. Note however that in 3GPP specifications, the term TRP may not be captured. Instead each TRP is represented by one SRI (SRS Resource Indicator) or one UL TCI state. The SRI or UL TCI state essentially provides an indicator of a spatial beam that the UE should use to target an uplink transmission towards a given TRP. Furthermore, although the below embodiments are discussed using SRIs, the embodiments are non-limiting and can be equally applicable to cases where SRIs are replaced by UL TCI states. In the discussion below, the PUSCH can refer to:
dynamically scheduled PUSCH only; that is, does not apply to configured grant PUSCH (CG-PUSCH)
both dynamically scheduled PUSCH and configured grant PUSCH.

Also, different multiplexing methods may be applied to A-CSI on dynamically scheduled PUSCH and CG-PUSCH, potentially using different configuration and scheduling parameter settings.

### A-CSI Repetition With PUSCH Over Multiple TRPs With Slot-Based Repetition

When using slot-based repetition (also known as Type A repetition), the PUSCH (potentially with UCI multiplexed onto it) is repeated in the same set of OFDM symbols in each slot. Thus, the amount of time-frequency resources occupied by each PUSCH repetition is the same across slots, even when the PUSCH repetitions are mapped towards different TRPs. In this case, it is relatively easy to ensure that the same DL RS mapping (including DMRS, PTRS) is applied across different TRPs, the same beta values (as defined in 3GPP TS38.213 clause 9.3) are used across different TRPs, etc., such that the same number of resource elements are reserved for a given UCI (e.g., A-CSI) across the repetitions (across slots and across TRPs). Then, this allows soft combining of the multiple repetitions of a given UCI, thus improving the transmission reliability of the given UCI. Here the given UCI include various types of UCI, for example, HARQ-ACK, A-CSI (including CSI part 1, CSI part 2), CG-UCI.

On the other hand, if repetitions across different TRPs are not exact duplication of each other in terms of resource usage (e.g., different DMRS mapping between two TRPs, different beta values between two TRPs), then, without enhancements, different number of resource elements may be obtained for a given UCI. This prevents soft combining of multiple repetitions across different TRP for a given UCI.
To resolve this problem, one method is to put in configuration and scheduling restriction such that all repetitions across all TRPs occupy the same amount of time-frequency resources, and have the same amount of resources for DMRS and PTRS, and apply the same beta values for a given UCI.
Another method is to allow repetition of UCI multiplexed onto PUSCH of one TRP only, and do not multiplex the UCI onto PUSCH of other TRP(s). In this case, the PUSCH configuration and scheduling can be different between different TRPs.

In one embodiment, when a UE is triggered for A-CSI reporting on PUSCH and the PUSCH is to be repeated over multiple TRPs (i.e., the UE is indicated with multiple SRIs or UL TCI states for the PUSCH), the A-CSI is also repeated multiple times with at least one A-CSI repetition per TRP.

In this embodiment, PUSCH is repeated multiple times towards multiple TRPs over multiple slots. The multiple TRPs are indicated to the UE by the gNB (e.g., via scheduling DCI) using either multiple different SRIs or multiple UL TCI states. When A-CSI is also triggered using the CSI request field in the scheduling DCI along with the PUSCH, the A-CSI is also repeated towards each of the multiple TRPs at least once. Different beams may be used for transmitting the A-CSI and PUSCH to different TRPs.

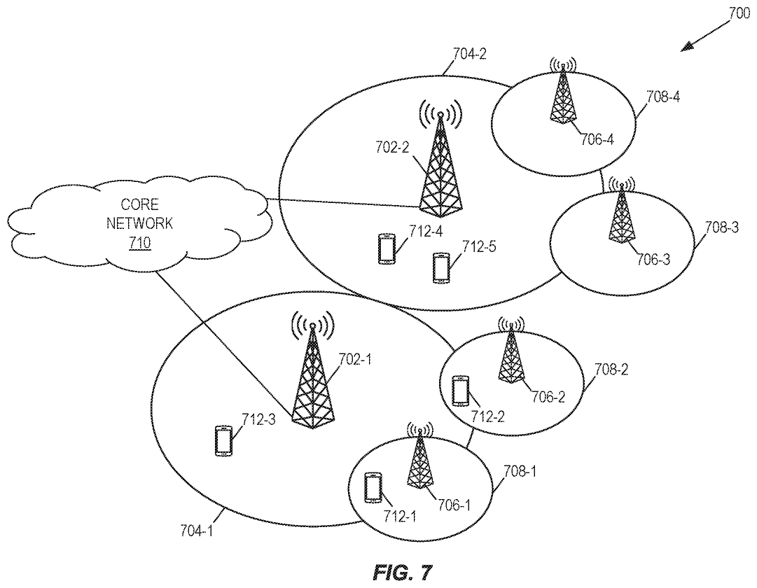

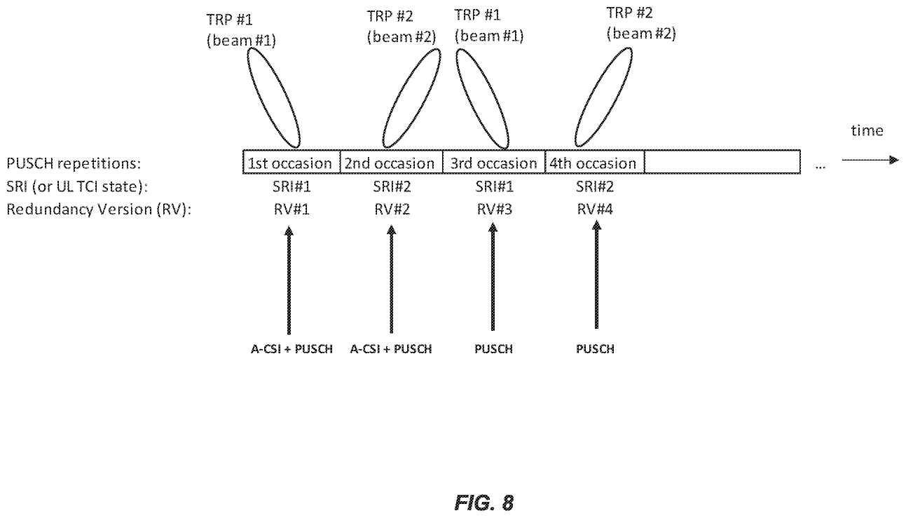

In one variant of this embodiment, the A-CSI is transmitted once towards each TRP in the first transmission occasion towards each TRP. An example of this embodiment is illustrated in FIG. 8 where PUSCH is repeated across four slots (where each repetition is a transmission occasion of the PUSCH). The UE uses beams 1 and 2 (which are indicated to the UE via SRI1 and SRI2) to transmit to TRP1 and TRP2. A-CSI is multiplexed with PUSCH on the 1^{st} transmission occasion targeted towards TRP1. Similarly, A-CSI is multiplexed with PUSCH on the 2^{nd} transmission occasion targeted towards TRP2. The same A-CSI content may be repeated in transmission occasions 1 and 2. The PUSCHs transmitted in different transmission occasions can be associated with different redundancy versions.

Note that in some embodiments, the repetitions for A-CSI and the repetitions for PUSCH can be different (e.g., A-CSI is repeated only twice while PUSCH is repeated four times in the example of FIG. 8). This might be beneficial as there may be different reliability requirements associated with A-CSI and PUSCH. As PUSCH may have a higher reliability than A-CSI, it may be beneficial to repeat PUSCH a higher number of times than the number of times A-CSI is repeated.

In another variant of this embodiment, which slots the A-CSI is multiplexed with PUSCH may depend on the mapping order in which the PUSCH repetitions are repeated towards different TRPs. This mapping order may be configured to the UE via a higher layer parameter.

For example, when the SRI mapping over PUSCH transmission occasions is configured to be cyclic as shown in FIG. 8, the A-CSI is multiplexed with PUSCH in the first PUSCH occasion (corresponding to the first transmission with SRI #1 targeting TRP #1) and the second PUSCH occasion (corresponding to the first transmission with SRI #2 targeting TRP #2).

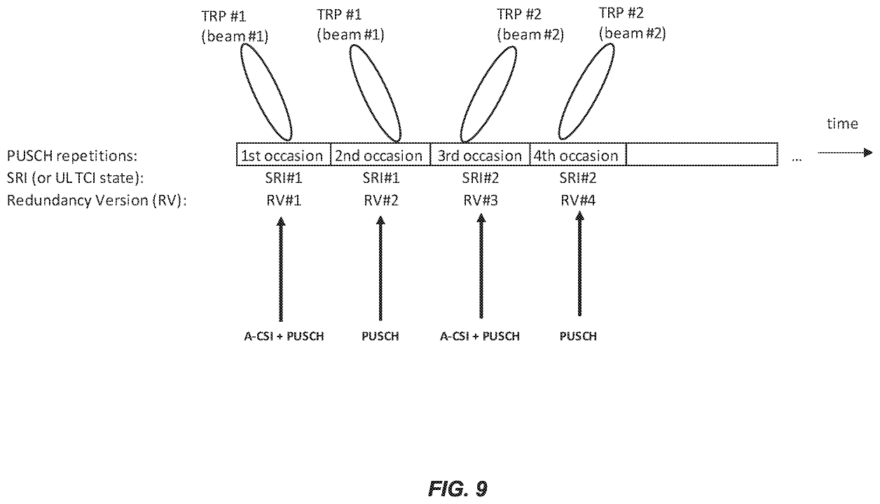

However, when the SRI mapping over PUSCH transmission is configured to be sequential as shown in FIG. 9, the A-CSI is multiplexed with PUSCH in the first PUSCH occasion (corresponding to the first transmission occasion SRI #1 targeting TRP #1) and the third PUSCH occasion (corresponding to the first transmission with SRI #2 targeting TRP #2).

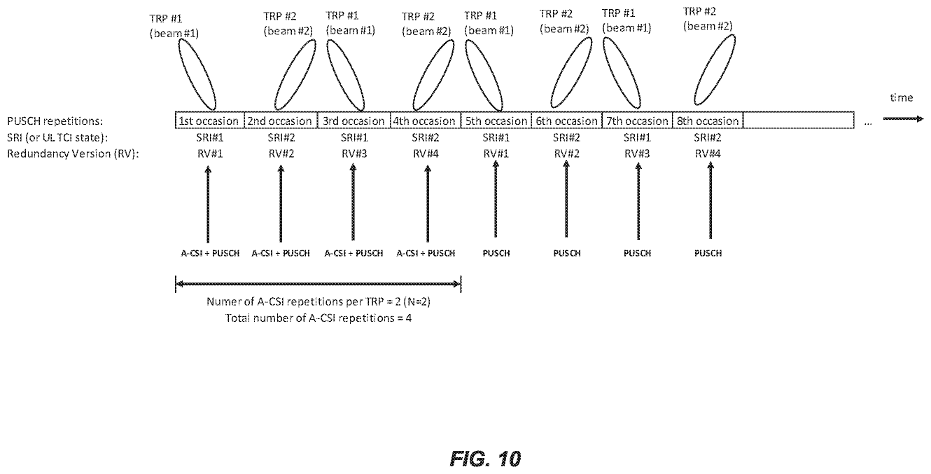

In another embodiment, the A-CSI is transmitted N≥1 times towards each TRP in the first transmission occasion towards each TRP. An example of this embodiment is illustrated in FIG. 10 where PUSCH is repeated across eight slots and the UE uses beams 1 and 2 to respectively transmit to TRP1 and TRP2. In this example, A-CSI is multiplexed with PUSCH on the first N=2 transmission occasions towards each TRP:
the 1^{st} and the 3^{rd} transmission occasions are the first N=2 transmission occasions where PUSCH is targeted towards TRP #1, and A-CSI is multiplexed with PUSCH in the 1^{st} and the 3^{rd} transmission occasions targeting TRP #1
the 2^{nd} and the 4^{th} transmission occasions are the first N=2 transmission occasions where PUSCH is targeted towards TRP #2, and A-CSI is multiplexed with PUSCH in the 2^{nd} and the 4^{th} transmission occasions

In some embodiments, the number N of times (e.g., the number of transmission occasions over which) A-CSI is repeated over multiple transmission occasions targeting multiple TRPs is signaled to the UE from the gNB:
In one example embodiment, N is configured as part of the PUSCH-TimeDomainResourceAllocation information element (IE) given in 3GPP TS 38.331 clause 6.3.2. For instance, N can be configured as part of PUSCH-TimeDomainResourceAllocation field or any of the subfields within PUSCH-TimeDomainResourceAllocation. Then, a codepoint in the ‘Time domain resource assignment’ field in UL DCI (as given in 3GPP TS 38.212) can be used to trigger a A-CSI that is repeated N times where the codepoint refers to the TimeDomainResourceAllocation in which Nis configured.
In another example embodiment, N is signaled as part of the CSI-ReportConfig IE given in 3GPP TS 38.331 clause 6.3.2. Hence, by triggering, via the CSI Request field in UL DCI, the CSI-ReportConfig where reportConfigType is configured as aperiodic and where N is configured, A-CSI can be repeated over multiple transmission occasions targeting multiple TRPs.
In another example embodiment, N is signaled as part of the CSI-AperiodicTriggerStateList IE given in 3GPP TS 38.331 clause 6.3.2. For instance, N can be configured as part of either CSI-AperiodicTriggerState or CSI-AssociatedReportConfigInfo. Hence, by triggering, via the CSI Request field in UL DCI, the CSI-AperiodicTriggerState or CSI-AssociatedReportConfigInfo in which N is configured, A-CSI can be repeated over multiple transmission occasions targeting multiple TRPs.

In some embodiments, Nis optionally configured under the condition that the associated CSI report is an aperiodic CSI report.

In a sub-embodiment of this embodiment, the N mentioned is the total number of repetitions
toward each TRP.
   E.g., if the total number of TRPs is 4, then total number of A-CSI repetitions towards all TRPs is 4*N and in this case the minimum number of repetitions of A-CSI is 4.
Towards all TRPs
   E.g., if total number of PUSCH repetitions is 16, and N=5, then only the first five PUSCH repetitions are used for A-CSI multiplexing and transmission no matter which TRPs they are targeting for.

In another embodiment, N is a predetermined value could be one or more of the following
number of TRPs
total number of PUSCH repetitions no matter how many TRPs are selected for the PUSCH repetitions

In another embodiment, the PUSCH repetitions can be a PUSCH transmission with A-CSI only.

In another embodiment, a bit map can be introduced to indicate which subset of the repetitions towards each TRP or towards all TRPs are used for A-CSI repetition.

In another embodiment, a bit map can be introduced to indicate which TRPs towards which the PUSCH repetitions will have A-CSI multiplexed and repeated.

### A-CSI Repetition With PUSCH Over Multiple TRPs With Type B PUSCH Repetition

In one embodiment, any of the embodiments discussed above can be extended to Type B PUSCH repetition where the PUSCH transmission occasions discussed above are replaced by either the nominal PUSCH repetitions or actual PUSCH repetitions.

In another embodiment, if a nominal repetition with Type B is segmented to multiple actual repetitions, only one of the segmented actual repetition is used for A-CSI transmission. E.g., first actual repetition is used for A-CSI repetition.

In another embodiment, for the total number of A-CSI repetitions over PUSCH repetitions with Type B, the maximum number is determined by the total number of nominal repetitions instead of by actual repetitions.

Similar to Type A, for PUSCH Type B repetition over multiple TRPs, it is also necessary to ensure that the same number of resource elements are reserved for a given UCI across the repetitions (across slots and across TRPs).
One method to achieve this is, using configurations (e.g., beta parameter) of one TRP (e.g., TRP #1) to derive the number of RE (called Q_{UCI} below) for a given UCI. Then, the same QUCI value is used on the other TRP(s) without calculation. The UCI can be: HARQ-ACK, CSI Type 1, CSI Type 2, CG-UCI, etc. Each UCI type needs its Qua value separately.
Another method is to allow repetition of UCI multiplexed onto PUSCH of one TRP only, and do not multiplex the UCI onto PUSCH of other TRP(s).

### A-CSI Repetition With PUSCH Over Multiple TRPs Without UL-SCH

In some embodiments, A-CSI can be repeated over multiple TRPs in the case where there is no UL-SCH triggered by the UL DCI.

In some embodiments, if A-CSI is repeated without UL-SCH data, the total number of repetitions is equal to total number of TRPs.

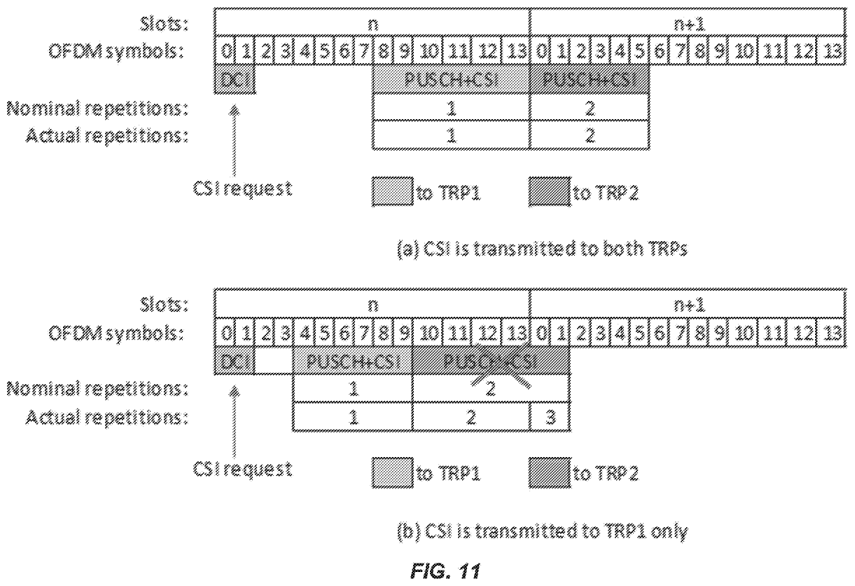

In a further embodiment, for PUSCH repetition Type B, when a UE receives a DCI that schedules aperiodic CSI report(s) or activates semi-persistent CSI report(s) on PUSCH with no transport block by a CSI request field on a DCI and multiple SRIs or UL TCI states are indicated in the DCI, the number of nominal repetitions is always assumed to be the same as the number of indicated SRIs or UL TCI states, regardless of the value of number0fRepetitions-r16 indicated in the TDRA field of the DCI or the number of repetitions configured in RRC. When the UE is scheduled to transmit a PUSCH repetition Type B with no transport block and with aperiodic or semi-persistent CSI report(s) by a CSI request field on a DCI, if the number of nominal repetitions determined by the number of SRIs or UL TCI states is greater than one and if the nth (n>=1) nominal repetition is not the same as the nth actual repetition, the nth nominal repetition is omitted. An example is shown in FIG. 11, where in FIG. 11(a) the nominal repetitions are the same as actual repetitions and the CSI is transmitted to both TRP1 and TRP2. While in FIG. 11(b), the 2^{nd} nominal repetition is not the same as the 2^{nd} actual repetition due to slot boundary crossing, in this case the CSI is only transmitted in the first repetition to TRP1.

### UL Channels/Signals of Different Priorities

Both A-CSI and PUSCH can be assigned a physical-layer priority (aka, PHY priority). Typically, two levels of PHY priorities are supported, namely, high priority and low priority.

### PUSCH Priority and Multiple TRP:

In one embodiment, the priority level of PUSCH can be assigned independently of single- vs multiple-TRP scheduling, i.e., the priority level of PUSCH can be assigned to be ‘high priority’ or ‘low priority’ regardless of the number of TRP the PUSCH is mapped to.

In another embodiment, the supported priority level of PUSCH is dependent of the number of TRP the PUSCH is mapped to. For example, if the PUSCH is mapped to a single TRP, then the PUSCH priority can be either ‘low’ or ‘high’, whereas if the PUSCH is mapped to multiple TRPs, PUSCH is always considered ‘high priority’.

In another embodiment, the priority level of PUSCH can be assigned, alternatively or additionally, taking into account if the PUSCH carries (a) UL-SCH only; (b) A-CSI only; (c) both A-CSI and UL-SCH. For example, for a PUSCH scheduled onto multiple TRPs,
if the PUSCH carries A-CSI only, then the PUSCH is considered low priority;
if the PUSCH carries UL-SCH only, then the PUSCH is considered high priority; Alternatively, if the PUSCH carries UL-SCH only, the PUSCH priority level is according to the ‘priority indicator’ in the DCI.
otherwise (i.e., PUSCH carries both A-CSI and UL-SCH), the PUSCH priority level is according to the ‘priority indicator’ in the DCI.

In another embodiment, the priority level of PUSCH mapped to multiple TRP has dependency on the scheduling DCI format. This may be especially useful if the DCI format(s) do not contain a ‘priority indicator’ field. For example, if scheduled by DCI format 0_0 or 0_1, then the PUSCH is given low priority. Otherwise, if scheduled by DCI format 0_0 or 0_2, then the PUSCH priority is considered high.

After the PUSCH priority is determined, all repetitions have the same priority, where the PUSCH may carry (a) UL-SCH only; (b) A-CSI only; (c) both A-CSI and UL-SCH. Then the priority is applied when the multiple repetitions overlap with other UL signals (e.g., SRS) and UL channels (e.g., PUCCH). For instance, if a PUSCH repetition is considered low priority, then the PUSCH repetition is dropped if it overlaps with another UL signal/channel of high priority.

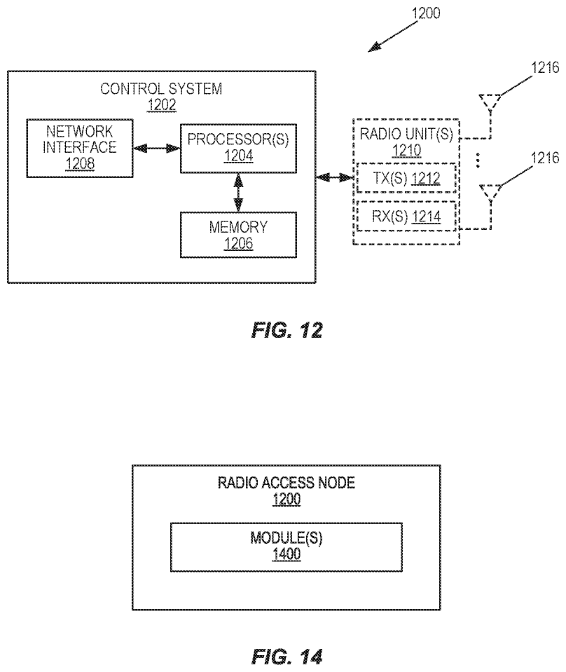

FIG. 12 is a schematic block diagram of a radio access node 1200 according to some embodiments of the present disclosure. Optional features are represented by dashed boxes. The radio access node 1200 may be, for example, a base station 702 or 706 or a network node that implements all or part of the functionality of the base station 702 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein. In some embodiments, the function(s) are implemented in software that is stored, e.g., in the memory 1206 and executed by the one or more processors 1204.

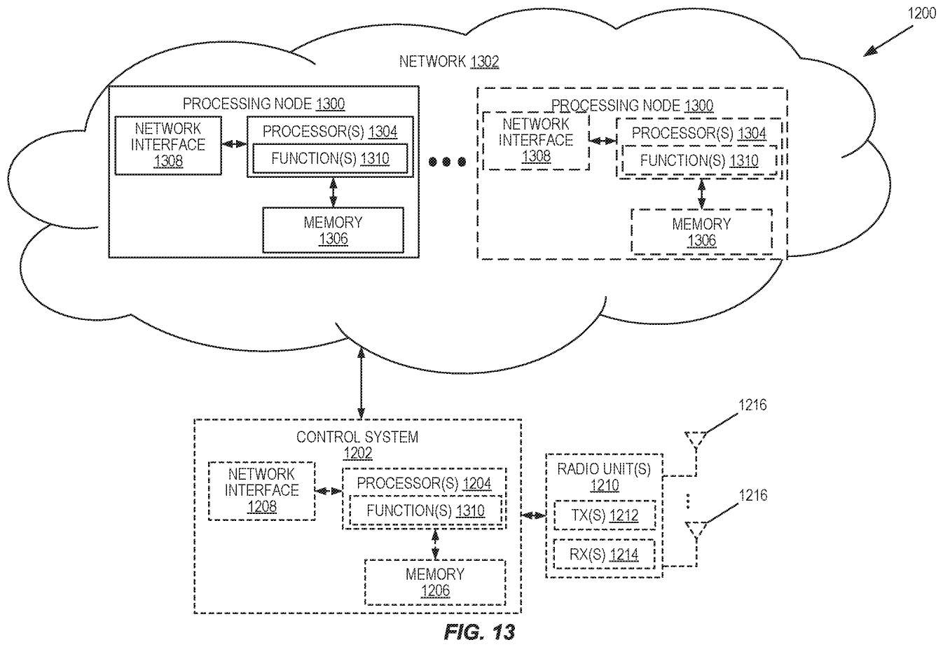

FIG. 13 is a schematic block diagram that illustrates a virtualized embodiment of the radio access node 1200 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICs, FPGAs, and/or the like), memory 1306, and a network interface 1308.

In this example, functions 1310 of the radio access node 1200 described herein are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein. This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

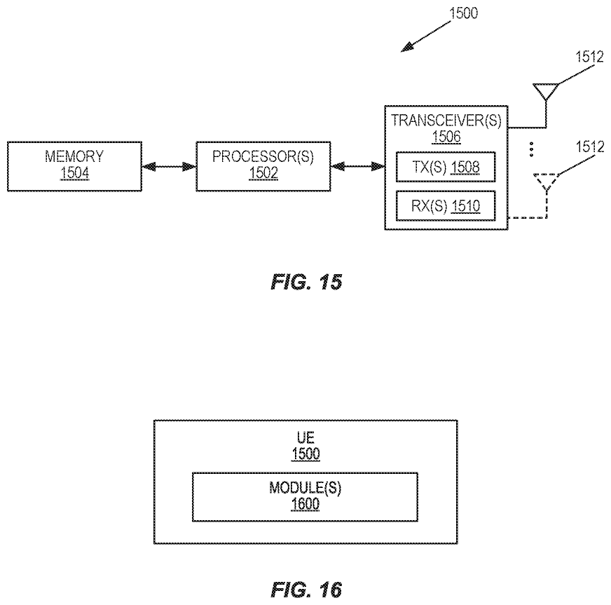

FIG. 15 is a schematic block diagram of a wireless communication device 1500 according to some embodiments of the present disclosure. As illustrated, the wireless communication device 1500 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the wireless communication device 1500 described above may be fully or partially implemented in software that is, e.g., stored in the memory 1504 and executed by the processor(s) 1502. Note that the wireless communication device 1500 may include additional components not illustrated in Figure such as, e.g., one or more user interface components (e.g., an input/output interface including a display, buttons, a touch screen, a microphone, a speaker(s), and/or the like and/or any other components for allowing input of information into the wireless communication device 1500 and/or allowing output of information from the wireless communication device 1500), a power supply (e.g., a battery and associated power circuitry), etc.

In some embodiments, a computer program including instructions which, when executed by at least one processor, causes the at least one processor to carry out the functionality of the wireless communication device 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the wireless communication device 1500 according to some other embodiments of the present disclosure. The wireless communication device 1500 includes one or more modules 1600, each of which is implemented in software. The module(s) 1600 provide the functionality of the wireless communication device 1500 described herein.

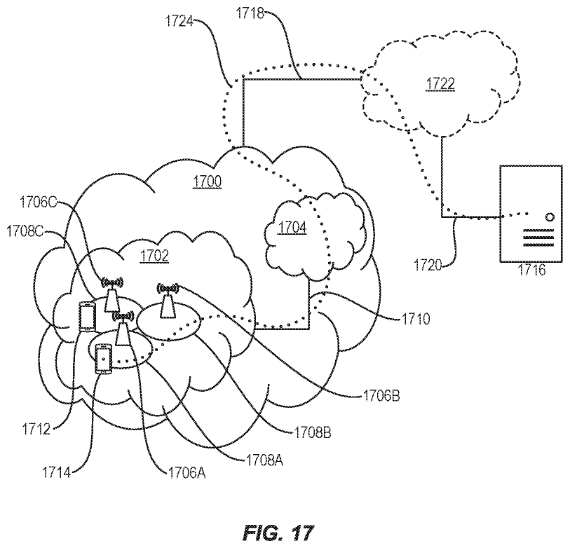

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

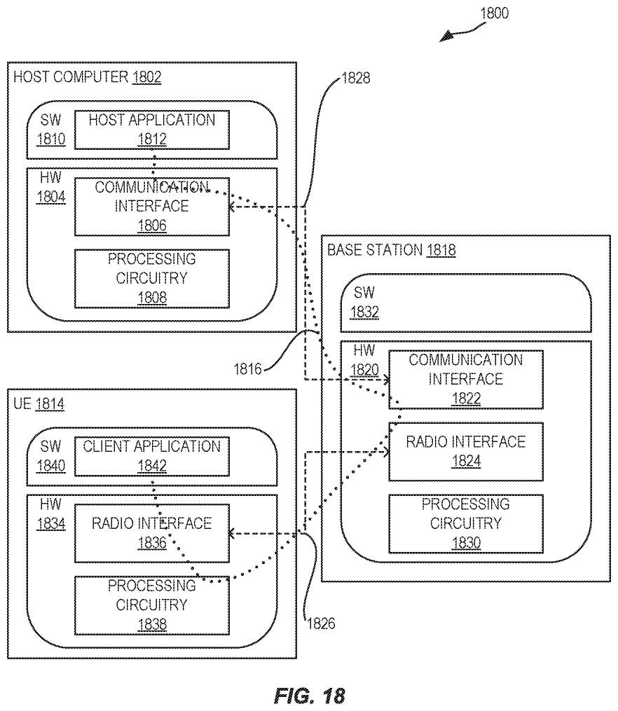

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICs, FPGAs, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAs, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAs, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above, or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer 1802's measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

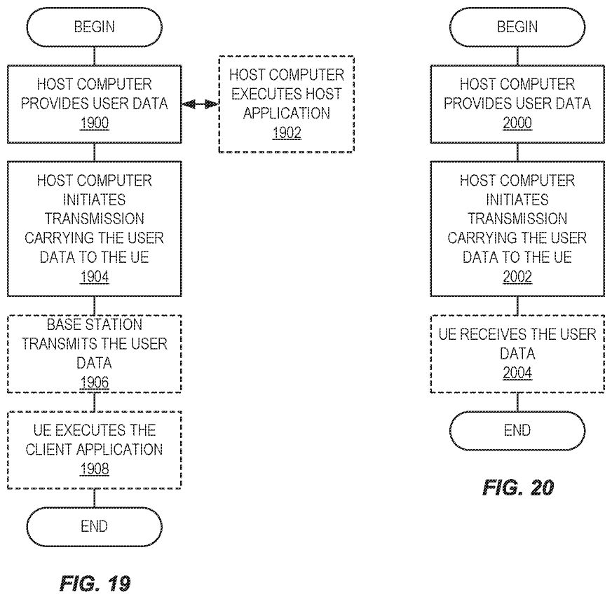

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

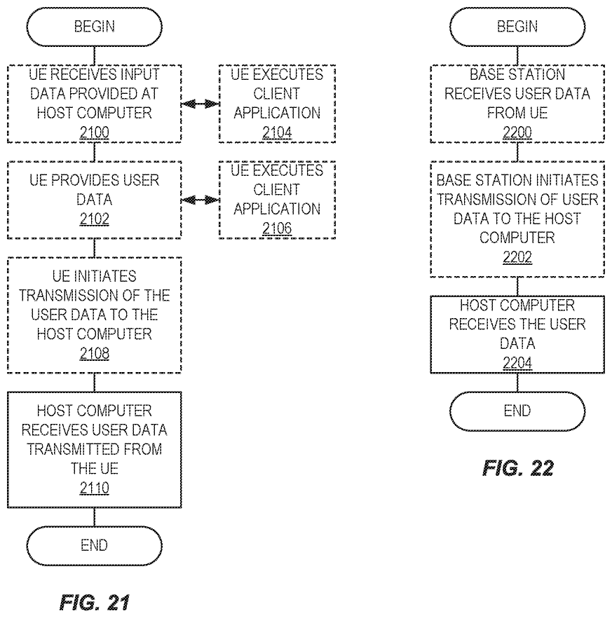

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some embodiments of the present disclosure are included here:

Embodiment 1: A method performed by a wireless device for providing feedback, the method comprising one or more of: repeating Physical Uplink Shared Channel, PUSCH, over multiple M>1 PUSCH occasions with P spatial relations and/or Uplink, UL, Transmission Configuration Indicator, TCI, states; and multiplexing Aperiodic Channel State Information, A-CSI, with PUSCH on N′>=1 PUSCH transmission occasions wherein N′ includes at least one PUSCH transmission occasion associated with each of the P spatial relations or UL TCI states.

Embodiment 2: The method of the previous embodiments wherein the PUSCH comprises: dynamically scheduled PUSCH only; and both dynamically scheduled PUSCH and configured grant PUSCH.

Embodiment 3: The method of the previous embodiments wherein, when a wireless device is triggered for A-CSI reporting on PUSCH and the PUSCH is to be repeated over multiple TRPs, the A-CSI is also repeated multiple times with at least one A-CSI repetition per TRP.

Embodiment 4: The method of the previous embodiments wherein the A-CSI is transmitted once towards each TRP in the first transmission occasion towards each TRP.

Embodiment 5: The method of the previous embodiments wherein the repetitions for A-CSI and the repetitions for PUSCH can be different.

Embodiment 6: The method of the previous embodiments wherein which slots the A-CSI is multiplexed with PUSCH may depend on the mapping order in which the PUSCH repetitions are repeated towards different TRPs.

Embodiment 7: The method of the previous embodiments wherein: when the SRI mapping over PUSCH transmission occasions is configured to be cyclic, the A-CSI is multiplexed with PUSCH in the first PUSCH occasion and the second PUSCH occasion; and/or when the SRI mapping over PUSCH transmission is configured to be sequential, the A-CSI is multiplexed with PUSCH in the first PUSCH occasion and the third PUSCH occasion.

Embodiment 8: The method of the previous embodiments wherein the A-CSI is transmitted N≥1 times towards each TRP in the first transmission occasion towards each TRP.

Embodiment 9: The method of the previous embodiments wherein the number N of times A-CSI is repeated over multiple transmission occasions targeting multiple TRPs is signaled to the wireless device from the base station.

Embodiment 10: The method of the previous embodiments wherein the number N is optionally configured under the condition that the associated CSI report is an aperiodic CSI report.

Embodiment 11: A method performed by a base station for receiving feedback, the method comprising one or more of: receiving repeated Physical Uplink Shared Channel, PUSCH, over multiple M>1 PUSCH occasions with P spatial relations and/or Uplink, UL, Transmission Configuration Indicator, TCI, states; and receiving multiplexed Aperiodic Channel State Information, A-CSI, with PUSCH on N5=1 PUSCH transmission occasions wherein N′ includes at least one PUSCH transmission occasion associated with each of the P spatial relations or UL TCI states.

Embodiment 12: The method of the previous embodiments wherein the PUSCH comprises: dynamically scheduled PUSCH only; and both dynamically scheduled PUSCH and configured grant PUSCH.

Embodiment 13: The method of the previous embodiments wherein, when a wireless device is triggered for A-CSI reporting on PUSCH and the PUSCH is to be repeated over multiple TRPs, the A-CSI is also repeated multiple times with at least one A-CSI repetition per TRP.

Embodiment 14: The method of the previous embodiments wherein the A-CSI is transmitted once towards each TRP in the first transmission occasion towards each TRP.

Embodiment 15: The method of the previous embodiments wherein the repetitions for A-CSI and the repetitions for PUSCH can be different.

Embodiment 16: The method of the previous embodiments wherein which slots the A-CSI is multiplexed with PUSCH may depend on the mapping order in which the PUSCH repetitions are repeated towards different TRPs.

Embodiment 17: The method of the previous embodiments wherein: when the SRI mapping over PUSCH transmission occasions is configured to be cyclic, the A-CSI is multiplexed with PUSCH in the first PUSCH occasion and the second PUSCH occasion; and/or when the SRI mapping over PUSCH transmission is configured to be sequential, the A-CSI is multiplexed with PUSCH in the first PUSCH occasion and the third PUSCH occasion.

Embodiment 18: The method of the previous embodiments wherein the A-CSI is transmitted N≥1 times towards each TRP in the first transmission occasion towards each TRP.

Embodiment 19: The method of the previous embodiments wherein the number N of times A-CSI is repeated over multiple transmission occasions targeting multiple TRPs is signaled to the wireless device from the base station.

Embodiment 20: The method of the previous embodiments wherein the number N is optionally configured under the condition that the associated CSI report is an aperiodic CSI report.

### TEXT OF APPENDIX

3GPP TSG-RAN WG1 Meeting #103 Draft R1-2009223

eMeeting, October 26th-Nov. 13, 2020

Agenda Item: 8.1.2.1

Source: Ericsson

Title: On PDCCH, PUCCH and PUSCH enhancements with multiple TRPs

Document for: Discussion

### 1 INTRODUCTION

In RAN1 #102e, the topic of PDCCH, PUSCH, and PUCCH enhancements by the use of multi-TRP in NR Rel-17 was first discussed. Some agreements were reached on evaluation assumptions and on some high-level scopes for further study.

In this contribution, we discuss some details on PDCCH, PUSCH, and PUCCH enhancements with multi-TRP and show some additional evaluation results.

### 2 DISCUSSION

The main motivation of using multiple TRPs is to achieve diversity. In FR1, diversity is utilized to prevent outages due to mainly fast fading. In FR2, channel blocking of the narrow beam between a TRP and UE is typically the issue addressed with the introduction of diversity, in order to maintain a continuous link. This is highly important for high reliability services such as controlling a manufacturing robot in a factory. Enhancements introduced in Rel-17 should be compatible with the Multi-TRP PDSCH schemes and PUSCH repetition schemes specified in Rel-16.

It is also desirable to have a single scheme for m-TRP robustness for PDCCH, PUCCH and PUSCH respectively that perform well in both FR1 and FR2.

### 2.2 PDCCH Enhancements with Multiple TRPs

In the last RANI. meeting, the following agreements were reached on PDCCH enhancement options/alternatives for further study [2]. In the following subsections, we will discuss these options/alternatives and our views.

### Agreement

To enable a PDCCH transmission with two TCI states, study pros and cons of the following alternatives:
Alt 1: One CORESET with two active TCI states
Alt 2: One SS set associated with two different CORESETs
Alt 3: Two SS sets associated with corresponding CORESETs
At least the following aspects can be considered: multiplexing schemes (TDM/FDM/SFN/combined schemes), BD/CCE limits, overbooking, CCE-REG mapping, PDCCH candidate CCEs (i.e. hashing function), CORESET/SS set configurations, and other procedural impacts.

### Agreement

For non-SFN based mTRP PDCCH reliability enhancements, study the following options:
Option 1 (no repetition): One encoding/rate matching for a PDCCH with two TCI states
Option 2 (repetition): Encoding/rate matching is based on one repetition, and the same coded bits are repeated for the other repetition. Each repetition has the same number of CCEs and coded bits and corresponds to the same DCI payload.
Study both intra-slot repetition and inter-slot repetition
Option 3 (multi-chance): Separate DCIs that schedule the same PDSCH/PUSCH/RS/TB/etc. or result in the same outcome.
Study both cases of DCIs in the same slot and DCIs in different slots
Note 1: Companies are encouraged to evaluate the different options based on agreed LLS assumptions for possible down-selection in RAN1 #103-e.
Note 2: The actual encoding/rate matching chain for PDCCH polar coding (i.e. 38.212 Sections 5.3.1/5.4.1/7.3.3/7.3.4) is not changed in the options above.

### Agreement

For mTRP PDCCH reliability enhancements, study the following multiplexing schemes
TDM: Two sets of symbols of the transmitted PDCCH/two non-overlapping (in time) transmitted PDCCH repetitions/non-overlapping (in time) multi-chance transmitted PDCCH are associated with different TCI states
Aspects and specification impacts related to intra-slot vs inter-slot to be discussed
FDM: Two sets of REG bundles/CCEs of the transmitted PDCCH/two non-overlapping (in frequency) transmitted PDCCH repetitions/non-overlapping (in frequency) multi-chance transmitted PDCCH are associated with different TCI states
SFN: PDCCH DMRS is associated with two TCI states in all REGs/CCEs of the PDCCH
Note: There is dependency between this scheme and AI 2d (HST-SFN)
Note: Combinations of the schemes are not precluded, and they can be discussed at a later stage.

### Agreement

For Alt 1 (one CORESET with two active TCI states), study the following
Alt 1-1: One PDCCH candidate (in a given SS set) is associated with both TCI states of the CORESET.
Alt 1-2: Two sets of PDCCH candidates (in a given SS set) are associated with the two TCI states of the CORESET, respectively
Alt 1-3: Two sets of PDCCH candidates are associated with two corresponding SS sets, where both SS sets are associated with the CORESET and each SS set is associated with only one TCI state of the CORESET
Note 1: A set of PDCCH candidates contain a single or multiple PDCCH candidates, and a PDCCH candidate in a set corresponds to a repetition or chance
Note 2: How one or more PDCCH candidates are counted for monitoring (for BD limit) is FFS
The note is applicable also to other alternatives

### Agreement

For Alt 1-2/1-3/2/3, study the following
Case 1: Two (or more) PDCCH candidates are explicitly linked together (UE knows the linking before decoding)
FFS: How the explicit linkage is derived/determined by the UE
Case 2: Two (or more) PDCCH candidates are not explicitly linked together (UE does not know the linking before decoding)

FFS: How the UE knows the linkage after decoding

### 2.2.1 Single PDCCH vs. PDCCH Repetition

### Agreement

For non-SFN based mTRP PDCCH reliability enhancements, study the following options:
Option 1 (no repetition): One encoding/rate matching for a PDCCH with two TCI states
Option 2 (repetition): Encoding/rate matching is based on one repetition, and the same coded bits are repeated for the other repetition. Each repetition has the same number of CCEs and coded bits and corresponds to the same DCI payload.
Study both intra-slot repetition and inter-slot repetition
Option 3 (multi-chance): Separate DCIs that schedule the same PDSCH/PUSCH/RS/TB/etc. or result in the same outcome.
Study both cases of DCIs in the same slot and DCIs in different slots
Note 1: Companies are encouraged to evaluate the different options based on agreed LLS assumptions for possible down-selection in RAN1 #103-e.
Note 2: The actual encoding/rate matching chain for PDCCH polar coding (i.e. 38.212 Sections 5.3.1/5.4.1/7.3.3/7.3.4) is not changed in the options above.

In the last meeting, various PDCCH enhancements were proposed. Fundamentally, it comes down to one of the two PDCCH transmission options, i.e., single-PDCCH approach vs multi-PDCCH approach.

### Single PDCCH Approach (i.e., Option 1. No Repetition):

In the single-PDCCH approach, a DCI is encoded, rate matched, modulated, and mapped to a PDCCH candidate resource. The PDCCH candidate is divided into multiple resource sets, each resource set is associated with a different TCI state. The PDCCH in each resource set is transmitted from a TRP associated with the TCI state. The resource of a PDCCH candidate may be divided in in frequency domain (e.g., REG bungles, CCEs, REGs), in time domain (e.g., different OFDM symbols), or in both time and frequency domain. The main benefit is receiver simplicity as a single PDCCH is received for a given DCI and large part of the legacy implementations may be reused.

However, partitioning a PDCCH candidate resource into multiple resource sets is not trivial, different partitions can have drastically different performance in presence of channel blocking. To compare PDCCH decoding performance with different resource partitions, we have evaluated various partition patterns. An example is shown in Figure Appendix1, where 5 REG bundle-based partition patterns between two TRPs are illustrated for a single PDCCH with AL=8. For simplicity, a CORESET with a single OFDM symbol is assumed. It is assumed that at any time one TRP is blocked by 20dB. Other assumptions can be found in Appendix A.

The evaluation results are shown in Figure Appendix2. It can be seen that the performance with patterns #4 and #5 is quite poor, pattern #5 almost does not work at all. Patterns #1 and #3 perform similar and are the best among the 5 patterns. Thus, we have the following observation:

Observation 1 The performance of single PDCCH approach depends very much on the resource partitions between two TRPs. Different partitions can lead to drastically different performance.

Figure Appendix1: Different partition patterns of a single PDCCH with AL=8 between two TRPs.

Figure Appendix2: Performance of a single PDCCH transmitted over two TRPs with different resource partition patterns shown in Figure Appendix1. AL=8, 40 bits+CRC DCI payload.

To understand the above behavior of single PDCCH approach, the coded PDCCH bits of the above example after rate matching are shown in Figure Appendix3. It can be seen that many coded bits appear twice in this case due to the low code rate. Ideally, if every coded bit appear twice after rate matching, the same set of coded bits should be transmitted in each of the two TRPs so that if one TRP is blocked, the PDCCH received from the other TRP can still be decoded.

Figure Appendix3: Coded PDCCH bits after rate matching, AL=8, 40 bits+CRC DCI payload.

For patterns #1 and #5 above, the corresponding partitions of coded bits between two TRPs are shown in Figure Appendix4. It can be seen that for pattern #1, it distributes the bits more evenly between two TRPs, so that the transmission from each TRP contains almost all the coded bits once. For pattern #5 though, it distributes the coded bits unevenly among the two TRPs, allocating many coded bits twice to a same TRP while puncturing out some other coded bits from each TRP. It is expected that if one TRP in blocked, it is hard to decode the PDCCH received from the other TRP as it contains only about half of the coded bits.

Observation 2 For single PDCCH approach, good performance can only be achieved when the coded bits are evenly distributed between two TRPs in case of channel blocking.

Figure Appendix4: Coded bits transmitted from two TRPs, (a) pattern #1, (b) pattern #5.

Next another example with the same DCI payload size is shown, but with AL=4. Similar partition patterns are evaluated, they are shown in Figure Appendix5. The performance of the 5 partition patterns is shown in Figure Appendix6. In this case, pattern#1 performs the worst and pattern #2 performs the best. The reason is that in this case, the code rate is doubled compared to AL=8 and there is no coded bit transmitted twice as shown in Figure Appendix7. In this case, for pattern #1, more important coded bits are likely concentrated to one TRP and in case that TRP is blocked, poor decoding performance is expected. With pattern #2, the coded bits are more evenly distributed between two TRPs and a better performance is seen.

Observation 3 For single PDCCH approach, the best partition pattern is aggregation level and DCI payload size dependent.

Figure Appendix5: Different partition patterns of a single PDCCH with AL=4 between two TRPs.

Figure Appendix6: Performance of a single PDCCH transmitted over two TRPs with different resource partition patterns in Figure Appendix5, AL=4, 40 bits+CRC DCI payload.

Figure Appendix7: coded PDCCH bits for AL=4, 40 bits+CRC DCI payload.

Given the above observation, it seems to be challenging to design good partitions or TCI state mappings to cover all aggregation levels and DCI payload sizes for the single PDCCH approach.

Proposal 1 For single PDCCH approach, further study is needed on resource partitions between two TRPs and their impact on PDCCH performance.

### Multi-PDCCH Approach (i.e., Option 2. PDCCH Repetition):

In the multi-PDCCH approach, a DCI is encoded, rate matched, modulated, and mapped to a PDCCH candidate resource allocated to each TRP. The same PDCCH is transmitted from each TRP on PDCCH resource allocated to the TRP. In other words, the PDCCH is repeated from different TRPs (or in specification language, reception with different TCI states). Depending on the resource allocation to each TRP, the repetition can be in either FDM or TDM manner. Since the DCI is encoded according to the resource available for each TRP, the probability of at least one PDCCH decoded successfully increases significantly in case of blocking.

Figure Appendix8 shows the performance of multi-PDCCH vs. single PDCCH for the same PDCCH examples discussed previously. For a fair comparison, the same amount of resources are assumed, e.g., AL=8 for single PDCCH and AL=4 for multi-PDCCH. It can be seen that for both AL=8 and AL=4 for single PDCCH, multi-PDCCH outperforms single PDCCH even with the best resource partition for single PDCCH.

Observation 4 Multi-PDCCH approach with PDCCH repetition outperforms single PDCCH approach in presence of blocking.

Figure Appendix8: performance of multi-PDCCH vs. single PDCCH in presence of blocking, (a) AL=8 for single PDCCH, AL=4 for multi-PDCCH; (b) AL=4 for single PDCCH, AL=2 for multi-PDCCH.

For PDCCH repetition, we think intra-slot repetition is the most applicable scenario. For inter-slot repetition, the K0/k2 in DCI need to be different in different slots since the number of slots between the PDCCHs and the same schedule PDSCH/PUSCH would be different. Therefore, it is no longer PDCCH repetition and thus, combing is no longer possible. In addition, the additional delay over multiple slots may not fit well for applications requiring low latency. Therefore, we have the following proposal

Proposal 2 Treat intra-slot PDCCH repetition with higher priority than inter-slot repetition.

As for Option 3, the motivation seems to be driven by using the existing Rel-PDCCH procedure in a UE transparent manner. However, a UE needs to determine the time offset between a decoded PDCCH and its schedule PDSCH/PUSCH.

Without an explicit linkage between two PDCCHs scheduling the same PDSCH/PUSCH, different time offsets may be determined depending on which PDCCH is decoded successfully, and different UE actions could be taken. This is further discussed in the following sections. Therefore, Option 3 cannot be fully transparent to the UE.

Observation 5 Multi-chance PDCCH transmission cannot be operated transparently to the UE.

### 2.2.2 COREST and Search Space Enhancements

### Agreement

To enable a PDCCH transmission with two TCI states, study pros and cons of the following alternatives:
Alt 1: One CORESET with two active TCI states
Alt 2: One SS set associated with two different CORESETs
Alt 3: Two SS sets associated with corresponding CORESETs
At least the following aspects can be considered: multiplexing schemes (TDM/FDM/SFN/combined schemes), BD/CCE limits, overbooking, CCE-REG mapping, PDCCH candidate CCEs (i.e. hashing function), CORESET/SS set configurations, and other procedural impacts.

Alt.1 is required for single PDCCH while Alt.2 and Alt.3 are for PDCCH repetitions. As discussed in the previous section, the challenge with single PDCCH is how to partition a PDCCH resource between two TRPs, which can have a significant impact on decoding performance in presence blocking, even though the changes from UE implementation perspective may be small.

Between Alt.2 and Alt.3, the required spec changes are rather similar. In Alt.2, spec change is needed to allow a SS set to be associated with two CORESETs, while in Alt.3, spec change is required to link two SS sets. With Alt.3, the two linked SS sets could have different configurations on monitoring periodicity/slot offset, monitoring pattern within slot, duration, and number of PDCCH candidates for each aggregation level. For example, if one SS set is configured with 2 PDCCH candidates, and the other linked SS set is configured with 4 PDCCH candidates for a given aggregation level, how to link the PDCCH candidates in the 2 SS sets would be an issue. In another example, if one SS set is configured with one monitoring occasion while the other SS set is configured with 2 monitoring occasions in a slot, how to link PDCCH candidates in the 2 SS sets is another issue. Thus, constraints may need to be introduced to handle different configurations and possible error cases. One possibility is to make the two SS sets to have the same configuration on those parameters, but then the additional flexibility of using two SS sets is unclear. With Alt.2, there is no such issues.

Other aspects such as non-overlapping CCEs, number of blind decodes, time offset definition between a PDCCH and its schedule PDSCH/CSI-RS/SRS/PUSCH, PUCCH resource allocation in a PUCCH resource set with more than 8 PUCCH resources, etc. are rather similar between Alt.2 and Alt.3. Table 1 is a summary of the possible spec impacts with Alt.1 to Alt.3.

Observation 6 Significant design efforts may be required on REG to TCI state mapping for Alt.1.

Observation 7 Rather similar spec changes required for Alt.2 and Alt.3. Additional constraints are needed for linked SS sets in Alt.3.

TABLE 1
Pros and cons of Alt. 1 to Alt. 3

Alt. 1 (with a single PDCCH) Alt. 2 Alt. 3
SS sets S1 S1 S1 S2
CORESETS one coreset coreset 1 coreset 2 coreset 1
coreset 2
AL L L/2 L/2 L/2 L/2
# of pdcch candidates per CORESET No change No change No change
# of pdcch candidates per SS set M(L) M(L/2)M(L/2)M(L/2)M(L/2)
single config per SS, M(L/2) = M(L) Duplicated config in
S1, S2
# of non-overlapping CCEs per SS no change aggregated from 2
coresets No change
# of non-overlapping CCEs per cell No change No change No change
Overbooking no change
(if over the limit, all candidates in S1 are dropped) no change at SS set
level
(all candidates in S1 is dropped when over limit) no change
(either s2 or both s1 and s2 will be dropped if over limit)
# of BDs no change aggregated from 2 coresets, depending on if
soft combining is performed aggregate from 2 SS sets, depending on if
soft combining is performed
CCE to REG mapping no change necessary no change (per coreset)
no change
PDCCH candidate to CCEs (i.e., hashing) no change no change no
change
CORESET config 2 TCI states + resource to TCI state mapping no change
no change
REG to TCI state mapping changes needed no change (per coreset)
no change (per coreset)
SS set config no change associate with 2 coresets, a single SS configure
Associate with another SS sets, some constraints are required for linked SS
sets
PDCCH to PSDCH/PUSCH/SRS/A-CSI-RS time offsets
(has impact on QCL, processing time budget) no change last symbol
of two linked candidates last symbol of two linked candidates
PUCCH resource allocation in resource set 0 with >8 resources no change
1st CCE and N_CCE of one candidate/coreset 1st CCE and N_CCE of
one candidate/coreset

### 2.2.3 Multiplexing Schemes

### Agreement

For mTRP PDCCH reliability enhancements, study the following multiplexing schemes
TDM: Two sets of symbols of the transmitted PDCCH/two non-overlapping (in time) transmitted PDCCH repetitions/non-overlapping (in time) multi-chance transmitted PDCCH are associated with different TCI states
Aspects and specification impacts related to intra-slot vs inter-slot to be discussed
FDM: Two sets of REG bundles/CCEs of the transmitted PDCCH/two non-overlapping (in frequency) transmitted PDCCH repetitions/non-overlapping (in frequency) multi-chance transmitted PDCCH are associated with different TCI states
SFN: PDCCH DMRS is associated with two TCI states in all REGs/CCEs of the PDCCH
Note: There is dependency between this scheme and AI 2d (HST-SFN)
Note: Combinations of the schemes are not precluded, and they can be discussed at a later stage.

FDM and TDM can be supported by both the single PDCCH approach and PDCCH repetition approach. Whether FDM or TDM is supported depends more on UE capability and whether it is for FR1 or FR2. In FR1, both FDM and TDM can be supported by a UE. In FR2, however, FDM requires UEs being capable of receiving from two TRPs at the same time, a feature not every UE is capable of. Thus, for FR2 TDM should be supported with higher priority as some UEs may only be able to receive a single repetition at a time (due to Rx panel/beam switching).

Proposal 3 TDM should be supported with higher priority in FR2. Both TDM and FDM are supported in FR1.

For both TDM and FDM, the resource for different TRPs should be orthogonal.

On SFN, it is more applicable to FR1. Since it can be transparent to the UE, further discussion doesn't seem to be needed for FR1. In FR2, it requires UE capability of simultaneous Rx from different TRPs, which not all UEs may be capable of. It may be further studied/evaluated in FR2.

### 2.2.4 PDCCH Repetition Within a Single CORESET

### Agreement

For Alt 1 (one CORESET with two active TCI states), study the following
Alt 1-1: One PDCCH candidate (in a given SS set) is associated with both TCI states of the CORESET.
Alt 1-2: Two sets of PDCCH candidates (in a given SS set) are associated with the two TCI states of the CORESET, respectively
Alt 1-3: Two sets of PDCCH candidates are associated with two corresponding SS sets, where both SS sets are associated with the CORESET and each SS set is associated with only one TCI state of the CORESET
Note 1: A set of PDCCH candidates contain a single or multiple PDCCH candidates, and a PDCCH candidate in a set corresponds to a repetition or chance
Note 2: How one or more PDCCH candidates are counted for monitoring (for BD limit) is FFS
The note is applicable also to other alternatives

Alt.1-1 is the single PDCCH approach that was discussed earlier. In Alt.1-2, a PDCCH is repeated in two PDCCH candidates in the same CORESET, each of the two PDCCH candidates is associated with a different TCI state. Due to the existing way of CCE based resource allocation for PDCCH candidates, only FDM can be supported. In order to support TDM operation, changes are required so that a PDCCH candidate could be located in one OFDM symbol in a CORESET configured with multiple symbols.

Observation 8 To support PDCCH repetition within a CORESET associated with two TCI states, changes are needed on PDCCH resource allocation for TDM operation.

In Alt.1-3, one of the TCI states of a CORESET needs be specified in a linked SS set. When the activated TCI states are updated for the CORESET, the TCI state for the linked SS sets also need to be updated. The linked SS sets can potentially have different configurations such as periodicity/slot offsets, monitoring pattern in a slot, etc., the benefit of such a scheme is unclear.

Observation 9 The benefit of Alt.1-3 with PDCCH repetition in two SS sets associated with a same CORESET activated with two TCI states is unclear.

### 2.2.5 Linkage Between PDCCH Candidates for PDCCH Repetitions

### Agreement

For Alt 1-2/1-3/2/3, study the following
Case 1: Two (or more) PDCCH candidates are explicitly linked together (UE knows the linking before decoding)
FFS: How the explicit linkage is derived/determined by the UE
Case 2: Two (or more) PDCCH candidates are not explicitly linked together (UE does not know the linking before decoding)

FFS: How the UE knows the linkage after decoding

In our view, the UE needs to know the linkage between PDCCH candidates for PDCCH repetition even if soft combining is not performed. This is not necessarily limited to Alt.1-2/1-3. It applies also to Alt.2 and Alt.3. Such a linkage is needed because the UE needs to determine the time offset between a decoded PDCCH and its scheduled PDSCH/PUSCH/CSI-RS/SRS for various purpose such as to determining whether the default TCI state(s) or the indicated TCI state(s) should be applied for a scheduled PDSCH or to determine the PUSCH processing time requirement can be met. Since the PDCCH may be decoded in either one of or both the PDCCH candidates, a single time reference is needed no matter over which PDCCH candidate the PDCCH is decoded successfully.

Observation 10 Explicit linkage is required between PDCCH candidates scheduling a same PDSCH/PUSCH/CSI-RS/SRS.

### 2.3 Multiple PUSCH Transmissions for Multi-TRP Reception

### 2.3.1 Dynamic Switching Between Single-TRP and Multi-TRP Based PUSCH Transmission

In some scenarios, the UE may be served with different types of traffic (i.e., URLLC traffic vs eMBB traffic). In these scenarios, it may be beneficial to support dynamic switching between multi-TRP based PUSCH transmission and single-TRP based PUSCH transmission. A similar principle was also used in NR Rel-16 where dynamic switching between multi-TRP based PDSCH reception and single-TRP based PDSCH reception is supported.

In current NR, for single-TRP based PUSCH transmission, a single spatial relation associated with the single SRS resource is used for PUSCH DMRS across all the PUSCH repetitions. However, for multi-TRP based PUSCH transmission, multiple spatial relations associated with an SRS resource may need to be used for PUSCH DMRS such that PUSCH transmissions are alternated targeting different TRPs across different repetitions.

Proposal 4 Dynamic switching between single-TRP based PUSCH and multi-TRP based PUSCH should be considered as part of PUSCH multi-TRP enhancements.

### 2.3.2 Codebook Based vs Non-Codebook Based PUSCH

In RAN1 #102-e, the following agreement was made:

### Agreement

To support single DCI based M-TRP PUSCH repetition scheme(s), up to two beams are supported. RANI. shall further study the details considering,
1. Codebook based and non-codebook based PUSCH
2. Enhancements on SRI/TPMI/power control parameters/any other

Note1: Companies are encouraged to provide additional details on how above enhancements are applied to different PUSCH repetitions (e.g. mapping between PUSCH repetitions and beams)

Note2: Studying enhancements/aspects related to TA is not precluded.

In current NR, there is only a single SRS resource set allowed for SRS with higher layer parameter usage set to either ‘codebook’ or ‘nonCodebook’. Power control parameter such as alpha, p0, etc. and pathloss reference RS for SRS are currently configured at the SRS resource set level. Given that the power control parameters and pathloss reference RS in general may be different for different TRPs, to minimize specification impact, the simple approach seems to be to increase the number of SRS resource sets with usage set to ‘codebook’ to two. This way different power control and pathloss reference RSs can be configured per SRS resource set targeting different TRPs.

Observation 11 Given power control parameters and path loss reference RS are configured at SRS resource set level, the simple extension to support two TRPs is to increase the number of SRS resource sets with ‘usage’ set to ‘codebook’ or ‘nonCodebook’ to two.

Proposal 5 To support PUSCH targeting 2 TRPs, increase the number of SRS resource sets with ‘usage’ set to ‘codebook’ or ‘nonCodebook’ to two in NR Rel-17.

A first issue that needs to be considered for codebook-based PUSCH is how to indicate different spatial relations for PUSCH repetitions targeting two different TRPs. For PUSCH, its spatial relation is defined by the spatial relation of the corresponding SRS resource(s) indicated by the SRI in the corresponding DCI. For codebook based PUSCH, to indicate two different spatial relations targeting two different TRPs, the UE needs to be indicated with two different SRS resources or SRIs. For codebook-based PUSCH, only a single SRI can be indicated in NR Rel-15/16. Hence, to provide two spatial relations corresponding to two TRPs, two SRIs may need to be indicated to the UE. The two SRIs refer to two SRS resources in the two SRS resource sets corresponding to the two TRPs.

Proposal 6 For codebook based PUSCH targeting 2 TRPs, support in NR Rel-17 indicating two SRIs where the two SRIs correspond to SRS resources in two different SRS resource sets.

A second issue that needs to be considered for codebook-based PUSCH is how to indicate different TPMIs corresponding to the two different TRPs. For codebook-based PUSCH, only a single TPMI can be indicated in NR Rel-15/16. Hence, to provide two precoding matrices corresponding to two TRPs, indication of two TPMIs may need be supported in NR Rel-17.

Proposal 7 For codebook based PUSCH targeting 2 TRPs, support in NR Rel-17 indicating two TPMIs corresponding to the two TRPs.

Currently, NR supports only one SRS resource set for non-codebook based PUSCH and only one associated NZP CSI-RS which the UE uses to calculate the precoder used for the transmission of SRS(s). This is suitable for non-codebook based PUSCH transmission towards a single TRP. However, use of a single associated NZP CSI-RS to derive the precoders used for the transmission of SRS(s) is not suitable for multi-TRP PUSCH. Hence, multiple associated NZP CSI-RSs (one per TRP) to derive the precoders used for the transmission of SRS(s) targeted towards different TRPs needs to be supported in NR Rel-17. This can be easily achieved if the number of SRS resource sets for non-codebook based PUSCH is extended to two since one associated NZP CSI-RS can be configured per SRS resource set.

Proposal 8 For non-codebook based PUSCH targeting 2 TRPs, support two associated NZP CSI-RS resources via increasing the number of SRS resource sets for non-codebook-based PUSCH to two in NR Rel-17.

Another issue that needs to be considered for non codebook-based PUSCH is how to indicate different SRIs corresponding to the two SRS resource sets targeting two different TRPs. Hence, we make the following proposal:

Proposal 9 For non-codebook based PUSCH targeting 2 TRPs, support in NR Rel-17 indicating multiple SRIs where these SRIs correspond to SRS resources in two different SRS resource sets.

### 2.3.3 Spatial Relation Based Framework vs Unified TCI State Based Framework

In NR Rel-15/16, the spatial transmission properties for PUSCH are given by the spatial transmission properties associated with the SRS(s) configured in a SRS resource set with usage of ‘Codebook’ or ‘non-Codebook’. In NR Rel-17 feMIMO WI, one of the objectives is to introduce a TCI state for UL or a unified TCI state for both UL and DL. Hence, a natural question is whether PUSCH multi-TRP enhancements should be based on the existing spatial relation framework or the unified TCI state framework. Since the design details of the unified TCI state framework may take some time to settle in the multi-beam discussions, it is reasonable to start Rel-17 PUSCH multi-TRP enhancement discussions based on the Rel-15/16 spatial relation framework. However, when the design details of unified TCI state framework are stabilized in multi-beam discussions, the Rel-17 PUSCH multi-TRP enhancements can be extended to the unified TCI state framework.

Observation 12 For PUSCH multi-TRP enhancements, the Rel-15/16 spatial relation based framework can be first considered; the PUSCH multi-TRP enhancements can be extended to cover the unified TCI state framework once the Rel-17 design of unified TCI state framework is stable.

### 2.3.4 Power Control

Since the channels to different TRPs from a UE are generally different, different closed loops are needed for different TRPs for UL power control. Each TRP may also have different beams for reception, thus more than one closed loop may be needed for each TRP. Hence, this aspect needs to be taken into account during Rel-17 PUSCH multi-TRP enhancements. Specifically, how to differentiate close loops among TRPs and how to indicate multiple TPC commands targeting different TRPs are issues that need to be considered.

Proposal 10 For PUSCH multi-TRP enhancements, different power control close loops for different TRPs are to be considered in NR Rel-17.

### 2.3.5 Multi-DCI Based PUSCH Transmission/Repetition Schemes

In RAN1 #102-e, the following agreement was made:

### Agreement

For M-TRP PUSCH reliability enhancement, support single DCI based PUSCH transmission/repetition scheme(s).
Further study multi-DCI based PUSCH transmission/repetition scheme(s) to identify potential gains and required enhancements.

Note: This agreement does not reflect any prioritization of single DCI based PUSCH transmission/repetition over multi-DCI based PUSCH transmission/repetition. Ran1 can further discuss that in the next meeting

One of the benefits of using multiple DCIs to schedule two PUSCHs targeting two different TRPs is that it allows the two PUSCHs to be scheduled with different MCSs, resource allocations, PMI and number of layers can be flexibly chosen to match the channel associated with the two TRPs. However, according to TS 38.214, there is the following scheduling restriction:

“The UE is not expected to be scheduled to transmit another PUSCH by DCI format 0_0, 0_1 or 0_2 scrambled by C-RNTI or MCS-C-RNTI for a given HARQ process until after the end of the expected transmission of the last PUSCH for that HARQ process.”

The 3GPP text above then states that the reception of PDCCH for next PUSCH corresponding to the same HARQ process cannot occur until the previous PUSCH has been transmitted. In Figure Appendix9, an illustration of this PUSCH scheduling restriction is given. In this figure, PDCCH1 and PDCCH2, schedule an initial PUSCH and a retransmitted PUSCH corresponding to the same HARQ process. Hence, as shown in the figure, PDCCH2 can only be received by the UE after the end of the initial PUSCH transmission scheduled by PDCCH1. Hence, with current NR specification, meeting strict latency requirements is challenging when PUSCH repetitions are scheduled with multiple DCIs. Note that this involves transmissions on same HARQ process (i.e., transmitting the same TB with different RVs via two PUSCHs on the same HARQ process).

Observation 13 For PUSCH repetition over multi-TRP enhancements using two different DCIs, meeting strict latency requirements is challenging.

Figure Appendix9. Transmission of two PUSCHs scheduled with two uplink DCIs for the same HARQ process according to restrictions specified in NR Rel-15/16.

For URLLC, it is beneficial to allow back-to-back (re)transmission of PUSCH over multiple TRPs where the PUSCHs are scheduled by different DCIs. In this way both reliability and reduced latency are addressed. Back-to-back PUSCH repetition using different DCIs is demonstrated in Figure Appendix10.

Observation 14 For PUSCH repetition over multi-TRP enhancements using two different DCIs, allow back-to-back (re)transmission of PUSCH over multiple TRPs is beneficial.

Figure Appendix10. An example of back-to-back PUSCH repetitions using different DCIs

Proposal 11 Consider allowing back-to-back scheduling of PUSCH repetitions via multiple DCIs over multiple TRPs in NR Rel-17.

### 2.3.6 M-TRP CG PUSCH Reliability

In RAN1 #102-e, the following agreement was made:

### Agreement

Further study M-TRP CG PUSCH reliability enhancements in Rel-17.

Regarding this issue, we think it is beneficial to extend multi-TRP support for CG PUSCH. However, it should first be discussed if multi-TRP support should be extended for both CG PUSCH type 1 and CG PUSCH type 2. Since the SRI can be indicated via dynamic grant for CG PUSCH type 2, CG PUSCH type 2 provides the benefit of switching spatial relation information dynamically. On the other hand, for CG PUSCH type 1, SRI is preconfigured by higher layers hence switching spatial relations requires RRC reconfiguration. Hence, we propose that Multi-TRP support should be added for at least CG PUSCH type 2. Multi-TRP support for CG PUSCH type 1 can be further discussed.

Proposal 12 Support Multi-TRP reliability for at least CG PUSCH type 2 in NR, and Support of Multi-TRP reliability for CG PUSCH type 1 can be further discussed.

Furthermore, it should be noted that to extend multi-TRP support to CG PUSCH type 1, multiple instances of at least the following parameters need to be configured as part of ConfiguredGrantConfig where each instance corresponds to a different TRP:
precodingAndNumberOfLayers
srs-ResourceIndicator
p0-PUSCH-Alpha
powerControlLoopToUse
pathlossReferenceIndex

Observation 15 To extend multi-TRP support to CG PUSCH type 1, multiple instances of the following parameters need to be configured as part of ConfiguredGrantConfig: precodingAndNumber0fLayers, srs-ResourceIndicator, p0-PUSCH-Alpha, powerControlLoopToUse, and pathlossReferenceIndex.

### 2.3.7 Beam Mapping to PUSCH Repetitions

In RAN1 #102-e, the following agreement was made:

### Agreement

On the mapping between PUSCH repetitions and beams in single DCI based multi-TRP PUSCH repetition Type A and Type B, further study the following,
For both PUSCH repetition Type A and B, how the beams are mapped to different PUSCH repetitions (or slots/frequency hops),
Alt.1: cyclical mapping pattern (the first and second beam are

applied to the first and second PUSCH repetition, respectively, and the same beam mapping pattern continues to the remaining PUSCH repetitions).
Alt.2: sequential mapping pattern (the first beam is applied to the first and second PUSCH repetitions, and the second beam is applied to the third and fourth PUSCH repetitions, and the same beam mapping pattern continues to the remaining PUSCH repetitions).
Alt.3: Half-Half pattern (the first beam is applied to the first half of PUSCH repetitions, and the second beam is applied to the second half of PUSCH repetitions)
Alt.34: Other variants (e.g. configurable mapping patterns)
Note1: For PUSCH repetition type B, the variants considering slot level beam mapping with the same mapping principals (replacing repetition with slot) in Alt.1/2/3 are also included.
Note2: For PUSCH repetition type A and B with frequency hopping, the variants considering frequency hop level beam mapping with the same mapping principals (replacing repetition with frequency hop) in Alt.1/2/3 can also be studied further. Final selection of such schemes also depends on the number of beams allowed per PUSCH repetition.
For PUSCH repetition Type B, which repetition type that the beams shall consider for the mapping,
Alt.1: beams are mapped to the nominal repetitions
Alt.2: beams are mapped to the actual repetitions
Alt.3: beams are mapped to different slots (not in the granularity of actual/nominal repetition)
Alt.4: Other variants
Consider additional requirements on switching gap(s) between two PUSCH repetitions towards different TRPs considering beam switching latency aspects.
Note: use of the above solutions to multi-DCI based PUSCH repetition and TDMed PUSCH transmission without repetition (when there are agreed to support) is not precluded.

In NR Rel-16, both cyclic mapping pattern and sequential mapping pattern were specified for slot-based TDM repetition scheme and one of these two patterns can be higher layer configured. Hence, it is reasonable agree both these patterns for PUSCH repetition Types A and B. For PUSCH repetition Type B, we have a slight preference mapping beams to nominal repetitions.

Proposal 13 For the mapping between PUSCH repetitions and beams in single DCI based multi-TRP PUSCH repetition Type A and Type B, support higher layer configuration of either cyclic mapping pattern or sequential mapping patter in NR Rel-17.

Proposal 14 For PUSCH repetition Type B, spatial relations are mapped to nominal repetitions in NR Rel-17.

### 2.3.8 Aperiodic CSI on PUSCH

In NR up to Release 16, aperiodic CSI report is multiplexed only once with PUSCH even when PUSCH is repeated (i.e., A-CSI is multiplexed with PUSCH in the first PUSCH). If the A-CSI report is not correctly decoded by the gNB, the gNB discards the report and triggers UE for another A-CSI report. If the A-CSI is transmitted by the UE in a slot when the channel between the UE and a TRP is blocked, then the A-CSI cannot be received with sufficient quality and decoding of the A-CSI will fail at the gNB. To improve the reliability of A-CSI, it may be beneficial to repeat A-CSI over multiple PUSCHs transmitted targeting different TRPs.

Observation 16 If A-CSI is multiplexed on PUSCH in a slot when the channel between the UE and a TRP is blocked, A-CSI may not be received reliably by the gNB. To improve the reliability of A-CSI, it may be beneficial to repeat A-CSI over multiple PUSCHs transmitted targeting different TRPs in Rel-17.

Proposal 15 To improve A-CSI reliability, consider support for A-CSI multiplexing on multiple PUSCHs targeting multiple TRPs in NR Rel-17.

### 2.3.9 Evaluation Results

We have done some preliminary simulations on possible PUSCH performance improvement with two TRPs at 30GHz with 10dB channel blocking. Other simulation assumptions can be found in the appendix. The results are shown in Figure Appendix2, where results for MCS=6 and MCS=10 are shown. It can be seen that for both MCS, a large performance gain can be observed.

Figure Appendix11: PUSCH performance improvement with PUSCH repetition over two TRPs under indoor hot-spot scenario at 30 GHz

### 2.4 Multiple PUCCH Transmission for Multi-TRP Reception

### 2.4.1 Dynamic Switching Between Single-TRP and Multi-TRP Based PUCCH Transmission

Similar to the case in PUSCH, the UE may be served with different types of traffic (i.e., URLLC traffic vs eMBB traffic). Hence, it may be beneficial to support dynamic switching between multi-TRP based PUCCH transmission and single-TRP based PUCCH transmission.

Proposal 16 Dynamic switching between single-TRP based PUCCH and multi-TRP based PUCCH should be considered as part of PUCCH multi-TRP enhancements depending.

### 2.4.2 Multiple Spatial Relations

In current NR, for single-TRP based PUCCH transmission, a single spatial relation associated with the single PUCCH resource is used across all the PUCCH repetitions. However, for multi-TRP based PUCCH transmission, multiple spatial relations may need to be associated with a PUCCH resource (assuming PUCCH repetition is done using the same PUCCH resource) such that when the PUCCH resource is chosen by the ‘PUCCH Resource Indicator’ field in DCI, the PUCCH transmissions are alternated targeting different TRPs across different repetitions. Hence, how to activate/associate multiple spatial relations with a PUCCH resource needs to be further considered in NR Rel-17 feMIMO WI.

Proposal 17 For PUCCH multi-TRP enhancements, how to activate/associate multiple spatial relations for a PUCCH resource needs to be considered in NR Rel-17 feMIMO WI.

### 2.4.3 On Number of PUCCH Repetitions

In NR Rel-15, the number of slot-based PUCCH repetitions is configured by higher layers for each PUCCH format. Considering mixed traffic types for a UE and different traffic types may have different reliability and latency requirements, different number of repetitions (either slot-based or sub-slot based) may be needed for PUCCH associated with different traffic types and/or UCI types (e.g., HARQ ACK, SR, CSI). Hence, how to configure/indicate multiple number of PUCCH repetitions for PUCCH needs to be further discussed/considered in NR Rel-17 feMIMO WI.

Proposal 18 For PUCCH multi-TRP enhancements, how to configure/indicate the number of repetitions for PUCCH needs to be further discussed/considered in NR Rel-17 feMIMO WI.

### 2.4.4 Power Control

Similar to the case in PUSCH, different closed loops are needed for different TRPs for UL power control in the case of PUCCH. This is because each TRP may have different beams for PUCCH reception, thus more than one closed loop may be needed for each TRP. Hence, this aspect needs to be taken into account during Rel-17 PUCCH multi-TRP enhancements. Specifically, how to differentiate close loops among TRPs and how to indicate multiple TPC commands targeting different TRPs are issues that need to be considered.

Proposal 19 For PUCCH multi-TRP enhancements, consider power control enhancements related to different close loops and associated TPC commands targeting different TRPs.

### 2.4.5 Intra-Slot PUCCH Repetition

In addition to PUCCH reliability, low latency is also required for some URLLC applications. Although PUCCH reliability for PUCCH formats 1, 3 and 4 can be increased with inter-slot repetition targeting multiple TRPs, it also introduces extra delays. Hence, a balance between PUCCH reliability and PUCCH reception latency is needed. One way of achieving this balance is to consider intra-slot repetitions over different TRPs for PUCCH formats 1, 3 and 4 which can be considered during Rel-17 PUCCH multi-TRP enhancements.

Proposal 20 For PUCCH multi-TRP enhancements, consider intra-slot PUCCH repetitions for formats 1, 3 and 4 in NR Rel-17 feMIMO WI.

### 2.4.6 Evaluation Results

Some preliminary simulations have been done on possible PUCCH performance improvement with two TRPs at 30GHz with 10dB channel blocking. Other simulation assumptions can be found in the appendix. The results are shown in Figure Appendix3, where we have compared intra-slot repetition over two TRP vs. single TRP transmission with two times of the number of symbols without repetition for different PUCCH formats. It can be seen that under channel blocking, repetition over two TRPs performs much better than single TRP for the same total number of symbols.

Figure Appendix12: PUCCH performance improvement with repetition over 2 TRPs under indoor hot-spot scenario at 4 GHz.

### 3 CONCLUSION

Based on the discussion in the previous sections we propose the following:

Proposal 1 For single PDCCH approach, further study is needed on resource partitions between two TRPs and their impact on PDCCH performance.

Proposal 2 Treat intra-slot PDCCH repetition with higher priority than inter-slot repetition.

As for Option 3, the motivation seems to be driven by using the existing Rel-15/16 PDCCH procedure in a UE transparent manner. However, a UE needs to determine the time offset between a decoded PDCCH and its schedule PDSCH/PUSCH. Without an explicit linkage between two PDCCHs scheduling the same PDSCH/PUSCH, different time offsets may be determined depending on which PDCCH is decoded successfully, and different UE actions could be taken. This is further discussed in the following sections. Therefore, Option 3 cannot be fully transparent to the UE.

Proposal 3 TDM should be supported with higher priority in FR2. Both TDM and FDM are supported in FR1.

Proposal 4 Dynamic switching between single-TRP based PUSCH and multi-TRP based PUSCH should be considered as part of PUSCH multi-TRP enhancements.

Proposal 5 To support PUSCH targeting 2 TRPs, increase the number of SRS resource sets with ‘usage’ set to ‘codebook’ or ‘nonCodebook’ to two in NR Rel-17.

Proposal 6 For codebook based PUSCH targeting 2 TRPs, support in NR Rel-17 indicating two SRIs where the two SRIs correspond to SRS resources in two different SRS resource sets.

Proposal 7 For codebook based PUSCH targeting 2 TRPs, support in NR Rel-17 indicating two TPMIs corresponding to the two TRPs.

Proposal 8 For non-codebook based PUSCH targeting 2 TRPs, support two associated NZP CSI-RS resources via increasing the number of SRS resource sets for non codebook-based PUSCH to two in NR Rel-17.

Proposal 9 For non-codebook based PUSCH targeting 2 TRPs, support in NR Rel-17 indicating multiple SRIs where these SRIs correspond to SRS resources in two different SRS resource sets.

Proposal 10 For PUSCH multi-TRP enhancements, different power control close loops for different TRPs are to be considered in NR Rel-17.

Proposal 11 Consider allowing back-to-back scheduling of PUSCH repetitions via multiple DCIs over multiple TRPs in NR Rel-17.

Proposal 12 Support Multi-TRP reliability for at least CG PUSCH type 2 in NR, and Support of Multi-TRP reliability for CG PUSCH type 1 can be further discussed.

Proposal 13 For the mapping between PUSCH repetitions and beams in single DCI based multi-TRP PUSCH repetition Type A and Type B, support higher layer configuration of either cyclic mapping pattern or sequential mapping patter in NR Rel-17.

Proposal 14 For PUSCH repetition Type B, spatial relations are mapped to nominal repetitions in NR Rel-17.

Proposal 15 To improve A-CSI reliability, consider support for A-CSI multiplexing on multiple PUSCHs targeting multiple TRPs in NR Rel-17.

Proposal 16 Dynamic switching between single-TRP based PUCCH and multi-TRP based PUCCH should be considered as part of PUCCH multi-TRP enhancements depending.

Proposal 17 For PUCCH multi-TRP enhancements, how to activate/associate multiple spatial relations for a PUCCH resource needs to be considered in NR Rel-17 feMIMO WI.

Proposal 18 For PUCCH multi-TRP enhancements, how to configure/indicate the number of repetitions for PUCCH needs to be further discussed/considered in NR Rel-17 feMIMO WI.

Proposal 19 For PUCCH multi-TRP enhancements, consider power control enhancements related to different close loops and associated TPC commands targeting different TRPs.

Proposal 20 For PUCCH multi-TRP enhancements, consider intra-slot PUCCH repetitions for formats 1, 3 and 4 in NR Rel-17 feMIMO WI.

### 4 REFERENCES

[1] RP-193133, New WID: Further enhancements on MIMO for NR, Samsung, RAN #86, Sitges, December 2019.
[2] Chairman's notes, RAN1 #102e, Aug. 17-28 , 2020.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
A-CSI Aperiodic Channel State Information
AF Application Function
AMF Access and Mobility Function
AN Access Network
AP Access Point
ASIC Application Specific Integrated Circuit
AUSF Authentication Server Function
BWP Bandwidth Part
CCE Control Channel Element
Ce Control Element
CG Configured Grant
CP-OFDM Cyclic Prefix Orthogonal Frequency Division Multiplexing
CPU Central Processing Unit
CQI Channel Quality Information
CRI CSI-RS Resource Indicator
CSI Channel State Indicator
CSI-IM Channel-State Information Interference Measurement
CSI-RS Channel-State Information Reference Signal
DCI Downlink Control Information
DL Downlink
DMRS Demodulation Reference Signal
DN Data Network
DSP Digital Signal Processor
eNB Enhanced or Evolved Node B
FPGA Field Programmable Gate Array
gNB New Radio Base Station
gNB-CU New Radio Base Station Central Unit
gNB-DU New Radio Base Station Distributed Unit
HSS Home Subscriber Server
IoT Internet of Things
IP Internet Protocol
LTE Long Term Evolution
MAC Medium Access Control
MCS Modulation and Coding Scheme
MIMO Multiple Input Multiple Output
MME Mobility Management Entity
MTC Machine Type Communication
NEF Network Exposure Function
NF Network Function
NR New Radio
NRF Network Function Repository Function
NSSF Network Slice Selection Function
NZP Non-Zero Power
OTT Over-the-Top
PC Personal Computer
PCF Policy Control Function
PDCCH Physical Downlink Control Channel
PDSCH Physical Downlink Shared Channel
P-GW Packet Data Network Gateway
PMI Precoding Matrix Indicator
PUCCH Physical Uplink Control Channel
PUSCH Physical Uplink Shared Channel
QoS Quality of Service
RAM Random Access Memory
RAN Radio Access Network
RB Resource Block
RE Resource Element
RI Rank Indicator
ROM Read Only Memory
RRC Radio Resource Control
RRH Remote Radio Head
RTT Round Trip Time
SCEF Service Capability Exposure Function
SINR Signal to Interference Plus Noise Ratio
SMF Session Management Function
SRI SRS Resource Indicator
SRS Sounding Reference Signal
SSB Synchronization Signal Block
TB Transport Block
TCI Transmission Configuration Indicator
TDD Time Division Duplexing
TDRA Time-Domain Resource Allocation
TPMI Transmit Precoding Matrix Indicator
TRP Transmission/Reception Point
UDM Unified Data Management
UE User Equipment
UL Uplink
UPF User Plane Function
URLLC Ultra Reliable Low Latency Communication
ZP Zero Power

Those skilled in the art will recognize improvements and modifications to the embodiments of the present disclosure. All such improvements and modifications are considered within the scope of the concepts disclosed herein.

1. A method performed by a wireless device for providing feedback, the method comprising:
repeating a Physical Uplink Shared Channel, PUSCH, over multiple M>1 PUSCH occasions each associated with P>1 spatial relations or Uplink, UL, Transmission Configuration Indicator, TCI, states; and
multiplexing Aperiodic Channel State Information, A-CSI, with the PUSCH on N>=1 of the M>1 PUSCH transmission occasions wherein the N PUSCH transmission occasions include at least one PUSCH transmission occasion associated with each of the P spatial relations or the UL TCI states.

2. The method of claim 1 wherein the P spatial relations are indicated by P sounding reference signal, SRS, resource indicators, SRIs.

3. The method of claim 1 wherein the PUSCH comprises one of the group consisting of:
dynamically scheduled PUSCH; and
configured grant PUSCH.

4. The method of claim 1 wherein, when the wireless device is triggered for A-CSI reporting on the PUSCH and the PUSCH is to be repeated over multiple M>1 PUSCH occasions with P>1 spatial relations or UL TCI states, the A-CSI is also repeated multiple times with at least one A-CSI repetition per spatial relation or UL TCI state.

5. The method of claim 1, wherein N=P and the A-CSI is transmitted once using each spatial relation or UL TCI state in a first transmission occasion in which PUSCH is transmitted using each spatial relation or UL TCI state.

6. The method of claim 1, wherein the number of repetitions for the A-CSI and the number of repetitions for PUSCH can be different.

7. The method of claim 1, wherein the number of repetitions for A-CSI and the number of repetitions for PUSCH are the same when the UE receives a downlink control information, DCI, that schedules a PUSCH with no transport block.

8. The method of claim 1, wherein which slots the A-CSI is multiplexed with the PUSCH may depend on a mapping order in which the PUSCH repetitions are repeated using different spatial relations or UL TCI states.

9. The method of claim 1, wherein:
when P=2 and a Sounding Reference Signal Resource Indicator, SRI, mapping over the at least one PUSCH transmission occasion is configured to be cyclic, the A-CSI is multiplexed with the PUSCH in a first PUSCH occasion and a second PUSCH occasion; and/or
when P=2 and the SRI mapping over the at least one PUSCH transmission occasion is configured to be sequential, the A-CSI is multiplexed with the PUSCH in the first PUSCH occasion and a third PUSCH occasion.

10. The method of claim 1, wherein the A-CSI is transmitted N≥1 times using each spatial relation or UL TCI state in the first N PUSCH transmission occasions in which PUSCH is transmitted using each spatial relation or UL TCI state.

11. The method of claim 10 wherein a number N of times the A-CSI is repeated over multiple transmission occasions using each spatial relation or UL TCI states is signaled to the wireless device from the base station.

12. The method of claim 10, wherein the number N is optionally configured under a condition that an associated CSI report is an aperiodic CSI report.

13. The method of claim 1, wherein the PUSCH repetitions are actual PUSCH repetitions when the PUSCH transmission occasions are repeated with Type B PUSCH repetition.

14. The method of claim 1, wherein N is predetermined.

15. A method performed by a base station for receiving feedback, the method comprising:
sending to a wireless device information comprising an uplink grant for transmitting a Physical Uplink Shared Channel, PUSCH, over multiple M>1 PUSCH transmission occasions each associated with one of P>1 spatial relations and/or Uplink, UL, Transmission Configuration Indicator, TCI, states;
sending an Aperiodic Channel State Information, A-CSI, request to the wireless device to multiplex the A-CSI with the PUSCH; and
receiving multiplexed A CSI, with the PUSCH on N>=1 of the M>1 PUSCH transmission occasions, wherein the N PUSCH occasions include at least one PUSCH transmission occasion associated with each of the P spatial relations or UL TCI states.

16. The method of claim 15 wherein P>1 spatial relations and/or Uplink, UL, Transmission Configuration Indicator, TCI, states are indicated by P Sounding Reference Signal, SRS, resource indicators, SRIs.

17. The method of claim 15, wherein the PUSCH comprises one of the group consisting of:
dynamically scheduled PUSCH; and
configured grant PUSCH.

18. The method of claim 15, wherein, when a wireless device is triggered for A-CSI reporting on the PUSCH and the PUSCH is to be repeated over multiple TRPs, the A-CSI is also repeated multiple times with at least one A-CSI repetition per TRP.

19-25. (canceled)

26. A wireless device for providing feedback, comprising:
one or more transmitters;
one or more receivers; and
processing circuitry associated with the one or more transmitters and the one or more receivers, the processing circuitry configured to cause the wireless device to:
repeat a Physical Uplink Shared Channel, PUSCH, over multiple M>1 PUSCH occasions with each associated with P>1 spatial relations and/or Uplink, UL, Transmission Configuration Indicator, TCI, states; and
multiplex Aperiodic Channel State Information, A-CSI, with the PUSCH on N>=1 of the M>1 PUSCH transmission occasions wherein the N PUSCH transmission occasions include at least one PUSCH transmission occasion associated with each of the P spatial relations or the UL TCI states.

27. (canceled)

28. A base station for receiving feedback, comprising:
one or more transmitters;
one or more receivers; and
processing circuitry associated with the one or more transmitters and the one or more receivers, the processing circuitry configured to cause the base station to perform one or more of:
send to a wireless device information comprising a uplink grant for transmitting a Physical Uplink Shared Channel, PUSCH, over multiple M>1 PUSCH transmission occasions each associated with one of P>1 spatial relations and/or Uplink, UL, Transmission Configuration Indicator, TCI, states;
send a Aperiodic Channel State Information, A-CSI, request to the wireless device to multiplex the A-CSI with the PUSCH; and
receive multiplexed Aperiodic Channel State Information, A-CSI, with the PUSCH on N>=1 of the M>1 PUSCH transmission occasions, wherein the N PUSCH occasions include at least one PUSCH transmission occasion associated with each of the P spatial relations or UL TCI states.

29. (canceled)
